(19) United States
(12) Patent Application Publication
(10) Pub. No.: US 2021/0276280 A1
(43) Pub. Date: Sep. 9, 2021

(54) HIGH STRENGTH THERMOPLASTIC COMPOSITES

(71) Applicant: E I DU PONT DE NEMOURS AND COMPANY, Wilmington, DE (US)

(72) Inventors: Bryan Benedict Sauer, Wilmington, DE (US); Zachary R. Dillworth, Wilmington, DE (US); Mark Gary Weinberg, Wilmington, DE (US); Jacob G. Dickinson, Wilmington, DE (US)

(21) Appl. No.: 16/474,292

(22) PCT Filed: Feb. 23, 2018
(86) PCT No.: PCT/US18/19440

§ 371 Date: Jun. 27, 2019

Related U.S. Application Data
(60) Provisional application No. 62/464,400, filed on Feb. 28, 2017.

(51) Int. Cl. B29C 70/20

(52) U.S. Cl. CPC B29C 70/20; B29K 2101/12

(57) ABSTRACT

Voided carbon fiber tapes comprising from 18K to 125K carbon fibers, a thermoplastic resin having a viscosity of about 10 to about 150 Pa·s, at least 3 void areas, a fiber fraction ranging from about 35 to 70 percent, a void volume ranging from about 2 to about 50 percent, and at least 10 percent wetted carbon fibers may be used to prepare consolidated thermoplastic composites which exhibit flexural strengths greater than or equal to 75 percent of the theoretical flexural strength.

### OVERVIEW

Described herein are voided carbon fiber tapes, thermoplastic composite preforms comprising these voided carbon fiber tapes, consolidated thermoplastic composites prepared from these preforms, and processes for preparing the voided carbon fiber tapes as well as processes for preparing thermoplastic composites from these voided carbon fiber tapes.

Carbon fiber composites are much lighter than identical parts prepared from metal and have comparable or superior mechanical performance to the metal counterparts. As a result, composite materials are increasingly being used as replacements for metal parts to reduce weight in highly demanding applications, such as for example structural parts in automotive and aerospace applications.

Glass fiber composites have been found to be limited in stiffness compared with metallic materials such as steel and aluminum. Therefore, there is an increasing demand for carbon fiber composites which have excellent weight specific properties such as stiffness when compared to glass fiber composites but are typically more expensive than glass fiber composites.

Carbon fiber composites prepared from 3K to 12K carbon fiber tows (light tows) are usually easier to prepare and more expensive than carbon fiber composites prepared from heavier tows such as 18K to 125K tows (heavy tows), and fully consolidated carbon fiber thermoplastic composites prepared from 3K to 12K tows typically have flexural strengths of less than 75 percent of the theoretical flexural strength of the consolidated thermoplastic composite.

Carbon fiber based composites may be prepared using thermoset polymers or thermoplastic polymers. Composites prepared from thermoset polymers are typically easier to consolidate due to the ability of thermoset polymers, before curing, to more easily flow and wet the carbon fibers due to their low viscosity, typically resulting in a lower void level after curing of the thermoset polymer compared to many thermoplastic based composites comprising low levels of unwetted fibers. In order for thermoplastic composites to have desirable properties, the thermoplastic polymer must typically have a much higher viscosity than pre-cured thermoset polymers. The higher viscosity makes wetting of the carbon fibers more difficult.

Polymers which have viscosities of about 120 Pas or less when measured about 30° C. above the polymer melting point and are used to prepare high glass transition thermoplastic composites for use in aerospace applications, typically result in thermoplastic composites which may be brittle. In order to obtain desirable thermoplastic composites for aerospace applications, polymer viscosities of at least about 120 Pa·s to greater than 500 Pa·s are routinely used. However, the use of such high viscosity polymers make impregnation of carbon fiber tows difficult.

A main challenge in preparing carbon fiber based thermoplastic composites is obtaining complete impregnation of the carbon fibers after thermal pressing or molding which routinely becomes more difficult as the number of carbon fibers in the tows increase. As the number of carbon fibers in the carbon fiber tows increase, the ability to impregnate and wet the many individual fiber layers becomes more difficult. With light tows such as 3K or 6K, consolidation to low or no voids is possible. With 12K tows, and especially for 24K or higher tows, it becomes more difficult to obtain consolidation to low voids when a pressing time of only a few minutes is used with thermoplastics having viscosities between about 10 and 150 Pa·s. Thermoplastic composites that comprise high void levels (poor consolidation) result in composites that exhibit reduced mechanical properties due to carbon fibers which have not been impregnated.

H. M. EL-Dessouky, et. al., Ultra-Light Weight Thermoplastic Composites: Tow-Spreading Technology; 15^{th} European Conference on Composite Materials, Venice, Italy, 24-28 Jun. 2012 discloses flexural strengths of 830 MPa using a 12K woven carbon fiber and polyphenylene sulfide thermoplastic to prepare the thermoplastic composite. A flexural strength of 830 MPa corresponds to a percent of theoretical flexural strength for a composite with a bi-axially symmetric fabric of 70.4%.

U.S. Pat. No. 4,624,886 discloses the use of a plasticizer and a matrix polymer to substantially cause complete wetting of the filaments of the fibrous structure.

U.S. Pat. No. 5,171,630 discloses flexible towpregs comprising a plurality of towpreg plies which comprise reinforcing filaments and matrix forming material. The reinforcing filaments are substantially wet out by the matrix forming material such that the towpreg plies are substantially void free composite articles.

U.S. Pat. No. 7,790,284 discloses flexible, low bulk, pre-impregnated towpregs.

Carbon fiber tapes which are void free or comprise a low percentage of voids are typically necessary for use in the aerospace industry. Even with low viscosity thermoplastics, low void or void free tapes are typically made at low production rates or with very expensive powder coating at low to medium production rates. Making low void tapes from a variety of methods, including the many forms of pultrusion, becomes very expensive due to low production rates. The high expense is accommodated by the high value of the composites for aerospace applications. Carbon fiber tows having 18K to 125K carbon fibers typically make preparing void free or very low void tapes a low productivity process. Thus, there is a need for a lower cost tape which can be produced by using low cost carbon fiber tows having 18K to 125K carbon fibers and at high production rates which can be used to prepare consolidated thermoplastic composites and which exhibit unexpectedly high flexural strengths.

It would be desirable to prepare carbon fiber based thermoplastic composites from thermoplastic polymers having viscosities of about 150 Pas or less in combination with carbon fiber tows of 18K to 125K carbon fibers wherein the carbon fiber consolidated thermoplastic composite exhibits a flexural strength greater than or equal to 75 percent of the theoretical flexural strength.

It has now been discovered that consolidated thermoplastic composites can be prepared from 18K to 125K carbon fiber tapes where the tapes comprise a substantial level of dry carbon fibers and multiple void areas before high pressure consolidation. Highly voided carbon fiber tapes as disclosed herein allow for high production rates of such tapes. These voided carbon fiber tapes have a specific combination of number of carbon fibers, void volume, void areas, tape height, width, and width to height (width:height) ratio, percentage of wetted carbon fibers, fiber fraction, and thermoplastic resin viscosity. Consolidated thermoplastic composites prepared from these voided carbon fiber tapes exhibit flexural strengths greater than or equal to 75 percent of the theoretical flexural strength of the consolidated thermoplastic composite.

### BRIEF DESCRIPTION OF THE DRAWINGS

FIG. 1A is a magnified cross-section of a carbon fiber voided tape.

FIG. 1B is a further magnified view of a section of the cross-section of FIG. 1.

FIG. 2 is the same magnified cross-section as FIG. 1A showing several void areas.

FIG. 3 is a magnified cross-section of a voided tape showing several large void areas.

FIG. 4 shows the sequence of steps for preparing carbon fiber fabric layers by rapid fabric formation.

FIG. 5 shows the sequence of steps for preparing carbon fiber fabric layers by rapid fabric formation in which the voided tapes are spaced further apart than FIG. 4.

### DETAILED DESCRIPTION OF THE INVENTION

### Abbreviations

The claims and descriptions herein are to be interpreted using the abbreviations and definitions set forth below.

“h”, “hrs” refers to hours.
“%” refers to the term percent.
“volume %” or “vol %” refer to volume percent.
“wt %” refers to weight percent.
“parts” refers to parts by weight.
“K” refers to 1000. For example, 50K means 50,000.
“g” refers to grams

### Definitions

As used herein, the article “a” refers to one as well as more than one and does not necessarily limit its referent noun to the grammatical category of singular number.

As used herein, the terms “dry carbon fiber(s)” or “unimpregnated fibers” or “dry fibers” refer to carbon fibers which are visually unwetted by the thermoplastic resin of the voided tape based on a cross-sectional visual analysis of a voided tape. Visually unwetted means that the carbon fiber is not in direct physical contact with thermoplastic resin when a magnified cross-section image (200 magnification) of the voided tape is viewed by the human eye.

As used herein, the term “wet carbon fiber(s)” or “wetted carbon fiber(s)” refers to carbon fibers which are visually encapsulated or surrounded by the thermoplastic resin of the voided tape based on a cross-sectional visual analysis of a voided tape. Visually surrounded means that the surface of the carbon fiber appears to be in direct physical contact with thermoplastic resin when a magnified cross-section image (200 magnification) of the voided tape is viewed by the human eye.

As used herein, the term “void(s)” refers to the space(s) within a voided tape which comprise only a gas or air but the space may also be a vacuum. The space may be surrounded by thermoplastic resin and/or wetted carbon fibers such that the space is completely enclosed or the space may be partially enclosed. The thermoplastic resin and/or wetted carbon fibers provide a barrier between neighboring spaces. Voids may be of any size including micron diameter bubbles or several millimeter-wide spaces when the voided tape is viewed as a cross-section. The voids may be of various random shapes.

As used herein, the term “void volume” refers to the volume percent of the total volume of voided tape which are voids. Void volume is the sum of all the voids within the voided tape and is based on the total volume of the voided tape.

As used herein, the term “fiber fraction” refers to the part of total solids volume in the voided tape that is fiber. The total solids volume in the voided tape comprises carbon fibers and thermoplastic resin. A fiber fraction of 50 percent means that half of the total solids volume of the voided tape are fibers and the remaining 50 percent comprises thermoplastic resin. Fiber fraction comprises dry carbon fibers and wet carbon fibers.

As used herein, the terms “void free impregnated fiber regions” or “void free regions” refer to areas within the voided carbon fiber tape where the carbon fibers are visually impregnated or surrounded by the thermoplastic resin of the voided tape based on a cross-sectional visual analysis of a voided tape. Visually surrounded means that the surface of the carbon fiber appears to be in direct physical contact and surrounded with thermoplastic resin when a magnified cross-section image (200× magnification) of the voided tape is viewed by the human eye.

As used herein, the term “fabric fill factor” or “fill factor” refers to the percent of the total area fraction of a thermoplastic composite preform fabric layer, prepared from carbon fiber tape or tow, which is occupied by carbon fiber tape or tow. The fabric fill factor is directly related to the permeation path normal to the plane of the fabric, where if 50% of the fabric area passes air, then the fabric fill factor is 50%. If the passage of air is totally blocked, then the fabric fill factor is 100%. In other words, fill factor is the percent of the total area of a thermoplastic composite preform which comprises carbon fiber tape or tow and is a measure of the porosity, or level of free pathways through the fabric as viewed in the direction normal to the plane of the fabric.

As used herein, the terms “fiber lamellae layer thickness” and “lamellae layer thickness” refer to the height of individual compressed tapes in a given single layer of tape in a consolidated multi-layer thermoplastic composite. Each layer is defined by a given fiber orientation compared to the surrounding layers which may be above or below the given layer and may have the same or different orientation as the given fiber layer. Fiber lamellae layer thickness is preferably determined by dividing the consolidated composite thickness or height by the number of voided tape layers in the thermoplastic composite preform used to prepare the consolidated thermoplastic composite. For example, one woven or RFF fabric layer in a bi-axial fabric preform is two voided tape layers thick as is known in the art. Fiber lamellae layer thicknesses may also be determined from the cross-sections of the consolidated thermoplastic composite by directly measuring the fiber lamellae layer thickness.

As used herein, the term “void area” refers to regions within the voided tape which comprise an association of at least 100 individual dry carbon fibers. Each dry carbon fiber may or may not be in direct contact with the surface of another dry carbon fiber in the association. In other words, some or all of the dry carbon fibers may not be touching other dry carbon fibers in the association. Void areas are subsets of voids. In other words, void areas are contained within a void. Not all voids comprise dry carbon fibers but all void areas comprise at least 100 individual dry carbon fibers. Cross-section analysis of voided tapes may be used to determine the number of void areas and the relative volume of these void areas. Void area is expressed as mm².

As used herein, the term “tow” refers to a loose ribbon or bundle of thousands of carbon fibers aligned in the same direction. Tows are typically defined by the number of individual carbon fibers within the bundle or tow. A 50K tow has 50,000 individual carbon fibers.

As used herein, the term “consolidated” refers to thermoplastic composites which have been prepared by pressing thermoplastic composite preforms at a temperature and pressure to melt the thermoplastic resin and for a time period sufficient to allow the thermoplastic resin to penetrate the voids and impregnate dry carbon fibers to provide a void free thermoplastic composite.

As used herein, the term “void free” refers to a region or area of a thermoplastic composite or voided tape which comprises less than 1 percent voids. In other words, void free thermoplastic composites or void free tapes comprise less than about 1 percent voids.

As used herein, the terms “voided carbon fiber tape(s)” and “voided tape(s)” may be used interchangeably and refer to tapes which are prepared using carbon fibers and that comprise voids.

As used herein, the term “magnification” refers to the degree to which an object or article is enlarged by an optical instrument such as a microscope. For example, a magnification of 200 means that the object appears to be 200 times larger than the actual size of the object. A magnification of 200 may also be expressed as 200×.

As used herein, the term “squeeze-out” refers to the weight percentage of the thermoplastic composite preform that is pressed outside the original dimensions or shape of the preform while the thermoplastic composite preform is pressurized during thermal consolidation or stamp-pressing. In other words, squeeze-out refers to the percentage of thermoplastic resin and carbon fiber tape, based on the total weight of the preform, that is pressed outside the original dimensions or shape of the preform during thermal pressing to consolidate the preform.

As used herein, the term “stamp-pressing” refers to a high temperature and high pressure process to prepare consolidated thermoplastic composites. A thermoplastic composite preform is sandwiched between heated plates and compressed under pressure to the desired temperature, followed by rapid cooling under pressure. Equipment used for stamp-pressing may comprise unconstrained or free edges where solid and non-porous edge constraints are absent from the periphery of the equipment. An example of where an edge constraint is present would be a steel gasket or steel picture frame that prevents squeeze-out.

### Ranges and Preferred Variants

Any range set forth herein expressly includes its endpoints unless explicitly stated otherwise. Setting forth an amount, concentration, or other value or parameter as a range specifically discloses all possible ranges formed from any possible upper range limit and any possible lower range limit, regardless of whether such pairs of upper and lower range limits are expressly disclosed herein. Compounds, processes and articles described herein are not limited to specific values disclosed in defining a range in the description.

The disclosure herein of any variation in terms of materials, chemical entities, methods, steps, values, and/or ranges, etc.—whether identified as preferred or not—of the processes, compounds and articles described herein specifically intends to include any possible combination of materials, methods, steps, values, ranges, etc. For the purpose of providing photographic and sufficient support for the claims, any disclosed combination is a preferred variant of the processes, compounds, and articles described herein.

In this description, if there are nomenclature errors or typographical errors regarding the chemical name any chemical species described herein, including curing agents of formula (I), the chemical structure takes precedence over the chemical name. And, if there are errors in the chemical structures of any chemical species described herein, the chemical structure of the chemical species that one of skill in the art understands the description to intend prevails.

### Generally

Described herein are novel voided tapes which may be used to prepare single or multi-fabric layer thermoplastic composite preforms. The thermoplastic composite preforms disclosed herein, when consolidated into thermoplastic composites, exhibit a flexural strength greater than or equal to 75 percent of the theoretical flexural strength of the consolidated thermoplastic composite.

The novel voided tapes disclosed herein have a specific interrelationship between the number of carbon fibers, void volume, void areas, tape height, width, and width to height (width:height) ratio, percentage of wetted carbon fibers, fiber fraction, and thermoplastic resin viscosity. When thermoplastic composite preforms, prepared from voided tapes that comprise a specific range of values for each of the interrelated elements, are converted into consolidated thermoplastic composites, the flexural strength of these consolidated thermoplastic composites exhibit unexpectedly high flexural strengths which are at least 75 percent, preferably at least 80 percent, and more preferably at least 85 percent of the theoretical flexural strength of the consolidated thermoplastic composites.

The ability to achieve at least 75 percent of the theoretical flexural strength of the consolidated thermoplastic composites using 18K to 125K carbon fiber tows is quite unexpected. Typically, tapes prepared from 12K carbon fiber tows are much easier to impregnate with thermoplastic resin than when 18K or 50K tows are used. Tapes from 18K or 50K tows have longer and more convoluted paths the thermoplastic resin melt must traverse in order to fully wet and impregnate the carbon fiber tows.

It has now been surprisingly found that when voided carbon fiber tapes prepared from about 18K to 125K carbon fiber tows and which comprise a specific combination of properties are used to prepare consolidated thermoplastic composites, the consolidated thermoplastic composites exhibit at least 75 percent of the theoretical flexural strength of the consolidated thermoplastic composite.

Specifically, the voided tapes described herein comprise:
a) from 18K to 125K carbon fibers,
b) a thermoplastic resin having a viscosity of about 10 to about 150 Pas when measured using a capillary viscometer at a temperature 30° C. above the thermoplastic resin melting point and at a shear rate of 300 s⁻¹,
c) at least 3 void areas,
d) a fiber fraction ranging from about 35 to 70 percent,
e) a void volume ranging from about 2 to about 40 percent, and
   f) at least 10 percent wetted carbon fibers;
   wherein:
   the voided tape width ranges from about (0.00019 mm×the number of carbon fibers in (a)) to about (0.0016 mm×the number of carbon fibers in (a)),
   the voided tape width:height ratio ranges from about 10 to 250.

### Voided Tape

The voided tapes disclosed herein, which may be used to prepare thermoplastic composite preforms and consolidated thermoplastic composites, comprise from about 18K to 125K, preferably from about 24K to 100K, more preferably from about 24K to 60K, and most preferably from about 48K to 60K carbon fibers. The voided tapes are preferably prepared from a single carbon fiber tow of 18K to 125K carbon fibers.

The voided tapes have a void volume of from about 2 to 40 percent, preferably from about 5 to 40 percent, and more preferably from about 10 to 35 percent when measured according to a modified buoyancy method. The void volume is the sum of all the voids in the voided tape.

The voided tapes have a fiber fraction ranging from about 30 to 70 percent, preferably from 35 to 65 percent, and more preferably from 44 to 54 percent.

The voided tapes comprise at least 3 void areas, preferably at least 4 void areas, and more preferably at least 5 void areas. The number of void areas is determined by evaluating a cross-section of the voided tape and visually counting the number of void areas visible in the photo micrographs to the unaided eye at a magnification of 200 so long as the entire tape width and height are viewed as a whole. Typically, at least 100, preferably at least 200, more preferably at least 300 and most preferably at least 500 dry carbon fibers reside within each void area. Voids which exist as micron size air bubbles typically do not comprise dry carbon fibers.

The voided tapes described herein also comprise void free regions. Void free regions comprise thermoplastic resin and wetted carbon fibers. Void free regions may extend the entire height and/or width of a voided tape when viewed as a cross-section. Void free regions are located throughout the voided tape and may be any shape.

The voided tapes have a width ranging from about 3.4 mm to about 200 mm. For single tow tapes, voided tape width is related to the number of carbon fibers in the tow used to prepare the voided tape. The higher the number of carbon fibers in the voided tape, the wider the tape width. The minimum voided tape width may be determined by multiplying the number of carbon fibers by 0.00019 mm and may be expressed as (0.00019 mm×the number of carbon fibers). The maximum voided tape width may be determined by multiplying the number of carbon fibers by 0.0016 mm and may be expressed as (0.0016 mm×the number of carbon fibers). Preferably, the voided tape width ranges from about (0.0003 mm×the number of carbon fibers) to about (0.0010 mm×the number of carbon fibers). More preferably, the void tape width ranges from about (0.0004 mm×the number of carbon fibers) to about (0.0008 mm×the number of carbon fibers). For example, for voided tapes comprising 50K carbon fibers, the width ranges from about 9.5 mm to 80 mm, the preferred width ranges from about 15 mm to 50 mm, most preferably from about 20 mm to 40 mm. When attempting to make single tow voided tapes from 50K tows which are greater than 50 mm in width, there is significant friction and higher stress on the carbon fibers in the tow as they are spread out very thin which makes production of such wide and thin tapes difficult and potentially reducing yield or productivity/speed of the tape making process.

The voided tapes have a thickness or height which is interrelated to the tape width. The voided tapes have a width:height ratio ranging from about 9.5 to 250, preferably from about 15 to 200, more preferably from about 20 to 175, and most preferably from about 30 to 130. For voided tapes comprising 50K carbon fibers, the height may range from 0.1 mm to 1 mm, preferably from 0.13 mm to 0.9 mm and most preferably from 0.18 mm to 0.6 mm.

Voided tapes described herein comprise wetted carbon fibers and dry carbon fibers. For purposes of preparing voided tapes as described herein, at least about 10 percent, preferably between about 20 to 97 percent, more preferably between about 30 to 97 percent, and most preferably between about 40 to 97 percent of the total carbon fibers in the voided tape are wetted carbon fibers. The interrelationship between wetted carbon fibers, void areas (which comprise dry carbon fibers), and void volume play a critical role in the ability to prepare voided tapes which may be used to prepare consolidated thermoplastic composites which have desirable flexural strength values.

A voided tape contains substantially parallel, continuous carbon fibers and a thermoplastic resin. The voided tapes may be formed into various fabric structures which are then used to form thermoplastic composite preforms.

It is the specific interrelationships between the number of carbon fibers, void volume, void areas, tape height, width, and width to height (width:height) ratio, percentage of wetted carbon fibers, fiber fraction, and thermoplastic resin viscosity of the voided tape that allow the preparation of extremely strong consolidated thermoplastic composites from these voided tapes. Consolidated thermoplastic composites prepared from the voided tapes disclosed herein exhibit at least 75 percent of the theoretical flexural strength of the consolidated thermoplastic composite.

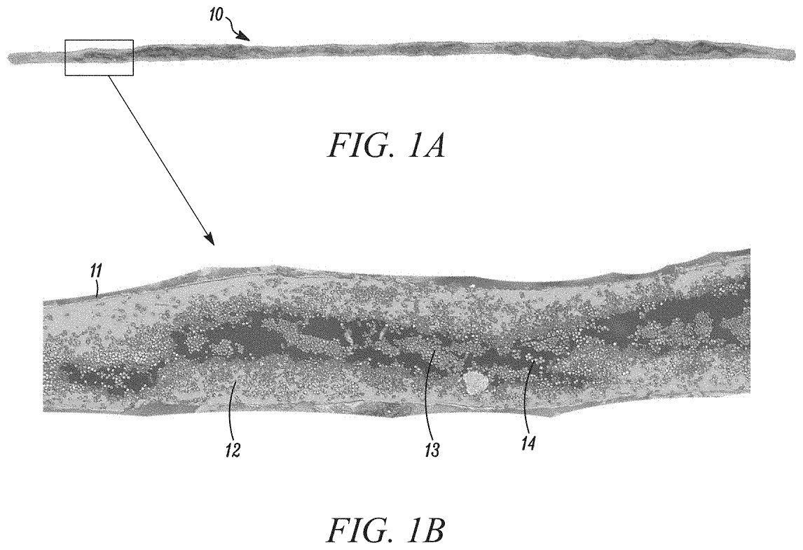

FIG. 1A shows a full width cross-section 10 of a voided tape disclosed herein. The cross-section is taken perpendicular to the fiber direction of the entire width of the tape. In order to obtain a magnified image of the entire cross-section of the voided tape, several separate images were taken at a magnification of 200 and digitally spliced together to make a complete micrograph image. FIG. 1B shows a section 11 of the voided tape of FIG. 1A which has been magnified to about 400. Region 12 is a void free impregnated fiber region of the voided tape and 13 and 14 are dry fibers in a void area. Carbon fibers in the cross-section appear as small circles or dots. Carbon fibers, when wetted by a thermoplastic resin, are contained within void free regions. The darkest regions in 11 are voids.

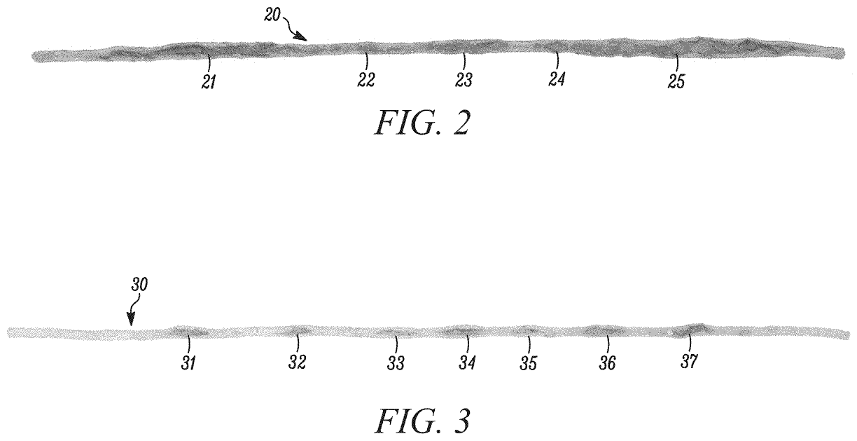

FIG. 2 shows the same cross-section 20 of the voided tape of FIG. 1A. The darkest regions of the voided tape are void areas and the major void areas are identified by 21 to 25. Other void areas are present in 20 but are not identified.

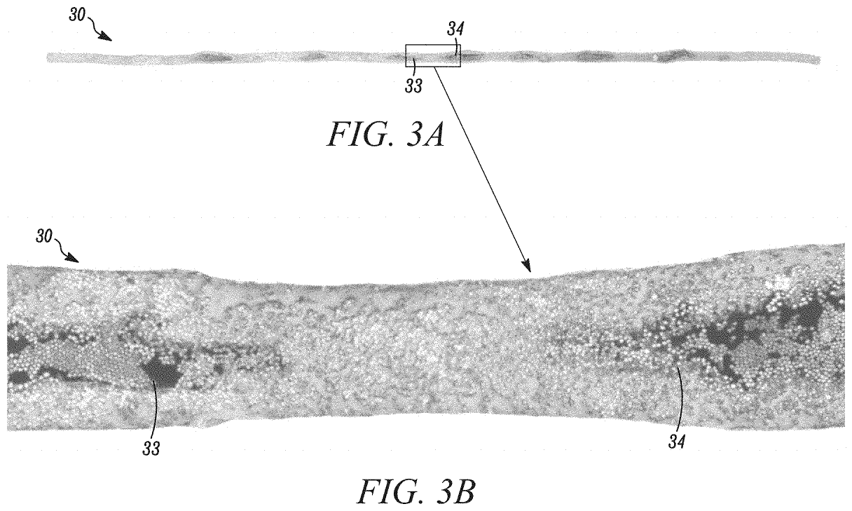

FIG. 3 is a cross-section 30 of a different voided tape than the tape of FIG. 1A and was taken perpendicular to the fiber direction of the entire width of voided tape. The darkest regions of the voided tape are void areas and the largest void areas are identified by 31 to 37. Other void areas are present in cross-section 30 but are not identified.

A commonly used method to prepare carbon fiber tapes is to coat the exterior surface of the carbon fiber tow with thermoplastic resin resulting in a tape with a surface coating of thermoplastic resin. However, such methods commonly result in a carbon fiber tape comprising a single large void area. Such carbon fiber tapes typically do not provide consolidated thermoplastic composites which have at least 75 percent of its theoretical flexural strength and are not desirable.

In the preparation of the voided tapes used to prepare thermoplastic composite preforms, the thermoplastic resin may be applied to the carbon fiber by conventional means such as, for example, various versions of pultrusion, powder coating, reactive thermoplastic impregnation, film lamination and impregnation, extrusion coating or a combination of two or more processes. When pultrusion is used, thermoplastic resin may be applied using a pultrusion chamber with an exit die where thermoplastic resin is applied on both sides of the carbon fiber tow and where impregnation pins within the chamber and/or a converging die are optionally used. Alternatively, a single sided coating carriage may be used where molten thermoplastic resin is extruded through a die onto one or both sides of the carbon fiber tow, preferably in spread form, where the carbon fiber tow is supported by a curved surface to drive the resin into the carbon fiber tow. A round or flattened wire coating die may also be used.

When a powder coating process is used, a thermoplastic resin powder, obtained by conventional grinding methods, is applied to the carbon fiber tow. The powder may be applied onto the carbon fiber tow by scattering, sprinkling, spraying, thermal or flame spraying, extruding, printing, or fluidized bed coating methods. Multiple powder coating layers can be applied to the carbon fiber tow. Optionally, the powder coating process may further comprise a step which consists in a post sintering step of the powder on the carbon fiber tow. Subsequently, brief thermopressing with heated nip rolls for example, is performed on the powder coated carbon fiber tow, with an optional preheating of the powder coated carbon powder tow.

The thermoplastic resin is spread throughout the cross section of the voided tape during impregnation rather than being an agglomeration or coating only on the surface of the carbon fiber tow. The voids created in the carbon fiber tow are distributed throughout the voided carbon fiber.

The voided tapes may also be prepared by making extremely wide sheets of impregnated carbon fibers having a width of several meters or more and which may comprise 1000K carbon fibers or more. Multiple carbon fiber tows can be spread in a parallel web and coated with resin followed by thermopressing with heated nip rolls to induce partial fiber wetting and make the voided tapes. As is known in the art, many other methods are available for applying resin to these fibrous webs other than coating. These carbon fiber sheets may then be cut or slit into voided tapes having the desired width and number of carbon fibers as disclosed herein. When such methods are used, it is preferred that the wide sheet tape is made with multiple parallel tows comprising 48K or more carbon fibers. Other processes can be used to make wide sheets of tape, including processes such as pultrusion, film, or powder impregnation.

A general process for preparing the voided tapes described herein includes the following process steps:
a) A spool of the desired carbon fiber tow size is unwound and guided over at least 2 metal rods and into a pultrusion device inlet opening. When 3 or more metal rods are used, the metal rods may be in an “s-wrap” configuration. These rods spread the carbon fibers in the dry tow and may also remove “twist” that may be present in the carbon fiber tow;
b) After the carbon fiber tow is spread by the metal rods, the spread carbon fibers enter a pultrusion device through an inlet opening of the device and into a heated impregnation chamber. The impregnation chamber is fed by a heated transfer line from an extruder so the chamber is filled with molten polymer resin.
c) In the impregnation chamber, the carbon fiber tow is pulled over one to six or more fixed spreading bars depending on the equipment used. These spreading bars aid wetting of the carbon fibers by the molten resin, and to spread the tape to increase the tape width:height ratio. These spreading bars cause additional spreading of the carbon fiber tow. The void volume of the carbon fiber tow is mostly defined within the impregnation chamber and may be controlled by the tow speed, degree of carbon fiber tow spreading, die dimensions, and polymer melt viscosity. Carbon fiber tow spreading can be regulated by the gap between the spreading bars that the carbon fiber tow is pulled through.
d) The voided tape comprising molten resin then exits the pultrusion device through an exit die. The die can be a variety of aspect ratios as is known in the art, and depending on the aspect ratios and shape, can partially aid in obtaining wide voided tapes with high width:height ratios. As the voided tape traverses through the exit die, excess resin is removed.
e) The voided tape is pulled downstream from the impregnation chamber by nip rolls or an electronic windup, and is wound onto a bobbin at speeds of 1 to 30 m/min or higher to provide voided carbon fiber tapes.

### Carbon Fiber

The carbon fiber used to prepare the voided tapes may be in the form of unidirectional carbon fiber (UD) tows. The carbon fiber may be prepared using any method known in the art. The carbon fibers are typically available in various tow sizes ranging from 12K to over 125K carbon fibers per tow. Examples of commercially available carbon fiber tows include Panex® 35 available from Zoltek Companies, Inc. which is a carbon fiber tow having 50K carbon fibers. Other heavy tow carbon fibers are available from a variety of companies including SGL Inc., Toho-Tenax. Inc., or Mitsubishi Rayon Inc. Carbon fiber can be made from PAN, pitch, or other carbon using a variety of methods known in the art.

The carbon fibers disclosed herein for use in preparing voided tapes preferably are sized carbon fibers. Typical sizing agents include thermoplastic polyurethanes, ethylene copolymers, and polyamide sizing agents.

The diameter of carbon fibers may range from about 5 μm up to about 15 μm.

### Thermoplastic Resin

Thermoplastic resins or polymers useful in the preparation of the voided carbon fiber tapes disclosed herein include without limitation, polypropylene, polyesters, polyamides, polyphenylene sulfide, and liquid crystalline polyesters. The thermoplastic resins can be amorphous or semi-crystalline. Polyamides used as the thermoplastic resin include aliphatic and semiaromatic polyamides and copolyamides. Blends of polyamides with other polyamides or with different polymers may also be used.

Fully aliphatic polyamide resins may be formed from aliphatic and alicyclic monomers such as diamines, dicarboxylic acids, lactams, aminocarboxylic acids, and their reactive equivalents. A suitable aminocarboxylic acid includes 11-amino-dodecanedioic acid. As disclosed herein, the term “fully aliphatic polyamide resin” refers to copolymers derived from two or more such monomers and blends of two or more fully aliphatic polyamide resins. Linear, branched, and cyclic monomers may be used. Star polymers may also be used. Carboxylic acid monomers useful in the preparation of fully aliphatic polyamide resins include, but are not limited to, aliphatic carboxylic acids, such as for example adipic acid (C6), pimelic acid (C7), suberic acid (C8), azelaic acid (C9), sebacic acid (C10), dodecanedioic acid (C12) and tetradecanedioic acid (C14). Useful diamines include those having four or more carbon atoms, including, but not limited to tetramethylene diamine, pentamethylene diamine, hexamethylene diamine, octamethylene diamine, decamethylene diamine, 2-methylpentamethylene diamine, 2-ethyltetramethylene diamine, 2-methyloctamethylene diamine; trimethylhexamethylene diamine and/or mixtures thereof. Suitable examples of fully aliphatic polyamide resins include PA6; PA66, PA46, PA610, PA612, PA614, P 613, PA 615, PA616, PA11, PA12, PA10, PA 912, PA913, PA914, PA915, PA616, PA936, PA1010, PA1012, PA1013, PA1014, PA1210, PA1212, PA1213, PA1214 and copolymers and blends of the same.

Preferred aliphatic polyamides include poly(hexamethylene adipamide) (PA66), polycaprolactone (PA6), and poly(tetramethylene hexanediamide) (PA46), and PA6/66. Blends of any of the foregoing aliphatic polyamides are also suitable, especially blends of PA66 and PA6.

Preferred semiaromatic polyamides include poly(hexamethylene terephthalamide/2-methylpentamethylene terephthalamide) (PA6T/DT); poly(decamethylene terephthalamide) (PA10T), poly(nonamethylene terephthalamide) (PAST), hexamethylene adipamide/hexamethylene terephthalamide/hexamethylene isophthalamide copolyamide (PA66/6T/6I); poly(caprolactam-hexamethylene terephthalamide) (PA6/6T); and poly(hexamethylene terephthalamide/hexamethylene isophthalamide) (PA6T/6I) copolymer. An especially preferred semiaromatic polyamide is PA6T/DT commercially available as Zytel® HTN501 from E.I. du Pont de Nemours, Wilmington, Del. Blends of aliphatic polyamides, semiaromatic polyamides, other thermoplastic resins and polymers, and combinations of these may also be used.

The thermoplastic resin should have a viscosity ranging from about 10 to about 150 Pa·s, preferably from about 10 to about 100 Pa·s, and most preferably from about 20 to about 80 Pas when measured at a temperature 30° C. above the thermoplastic resin melting point and at a shear rate of 300 s⁻¹. Below about 10 Pa·s many common lower glass transition temperature thermoplastics such as polyamides and polyolefins become less ductile with lower stress to failure. With the use of high glass transition temperature thermoplastics this effect becomes even more severe.

Rheology modifiers, heat stabilizers, colorants, antioxidants, lubricants, and other additives may be added as adjuncts to the thermoplastic resins.

The thermoplastic resin may further comprise a toughener for increasing ductility of the thermoplastic resin. Nonlimiting examples of tougheners which may be used in the thermoplastic resins described herein include maleic anhydride grafted ethylene/propylene/hexadiene copolymers, ethylene/glycidyl (meth)acrylate copolymers, ethylene/glycidyl (meth)acrylate/(meth)acrylate esters copolymers, ethylene/α-olefin or ethylene/α-olefin/diene (EPDM) copolymers grafted with an unsaturated carboxylic anhydride, ethylene/2-isocyanatoethyl (meth)acrylate copolymers, ethylene/2-isocyanatoethyl (meth)acrylate copolymers/(meth)acrylate esters copolymers, and ethylene/acrylic acid ionomers.

Specific examples of ethylene/α-olefin/diene (EPDM) copolymers grafted with an unsaturated carboxylic anhydride include those grafted with from about 0.1 wt. % to 5 wt. % maleic anhydride, preferably from about 0.5 wt. % to 4 wt. %, and more preferably from about 1 wt. % to 3 wt. %. Propylene is a preferred α-olefin. Specific examples of ethylene/α-olefin copolymers are those comprising from about 95-50 wt % ethylene and from about 5 to 50 wt % of at least one α-olefin with propylene, hexene, and octene being preferred α-olefins.

The quantity of thermoplastic resin in the voided tape is determined by the quantity of fibers used to prepare the voided tape. For example, if the fiber volume fraction in the voided tape is 48 percent, then the thermoplastic resin fraction is 52 percent of the total solids volume comprising the voided tape.

### Thermoplastic Composite Preforms

The voided tapes disclosed herein may be used to prepare thermoplastic composite preforms. These preforms may then be used to prepare consolidated thermoplastic composites by exposing the thermoplastic composite preforms to temperature and pressure for a given time period, preferably less than 5 minutes, to consolidate the thermoplastic composite preform.

Thermoplastic composite preforms may be prepared from carbon fiber fabrics formed from the voided tapes disclosed herein. The fabrics may be uni-directional or multi-directional. A uni-directional fabric comprises at least one voided tape or combination of multiple voided tapes in which all the voided tapes are aligned parallel to each other such that the fibers of all the voided tapes are orientated in the same direction in a given layer. Such fabrics may be used to form a single fabric layer of thermoplastic composite preforms or multiple fabric layers of thermoplastic composite preforms.

Thermoplastic composite preforms may optionally comprise fibers such as glass fibers, basalt fibers, and aramid fibers. These fibers may be used to prepare fabric layers which could be mixed with fabric layers prepared from the carbon fiber voided tapes described herein.

A cross-plied or cross-ply fabric consists of two uni-directional fabric layers stacked on top of each other and oriented in different directions. For example, a cross-plied layer can have 0/90 orientation where the two layer orientations are rotated 90 degrees with respect to each other. In other words, the first layer has an orientation of 0 degrees and the second layer which is placed on top of the first layer has an orientation which is 90 degrees to the first layer. Other angles of orientation in the cross-plied layers and fabrics can be used as is known in the art. Thermoplastic composite preforms with tri-axial symmetry, or other layups of several pre-form layers such as 0/−45/+45/90 may also be used.

A woven fabric layer is prepared by weaving the voided tapes using a weaving machine by weft insertion. Various types of woven fabrics can be prepared such as plain weaves, satin weaves, and twill weaves which are all common woven fabrics in the art.

Thermoplastic composite preforms may comprise a single layer of fabric or multiple layers of fabric. When multiple layers of fabric are used, the orientation of the voided tapes within each fabric layer may be different. For example, a single fabric layer thermoplastic composite preform comprises voided tapes in a single layer structure.

A multi-fabric layer thermoplastic composite preform comprises at least 2 fabric layers wherein one fabric layer is stacked on top of the first fabric layer. The fiber orientation between the two layers may be different or the same.

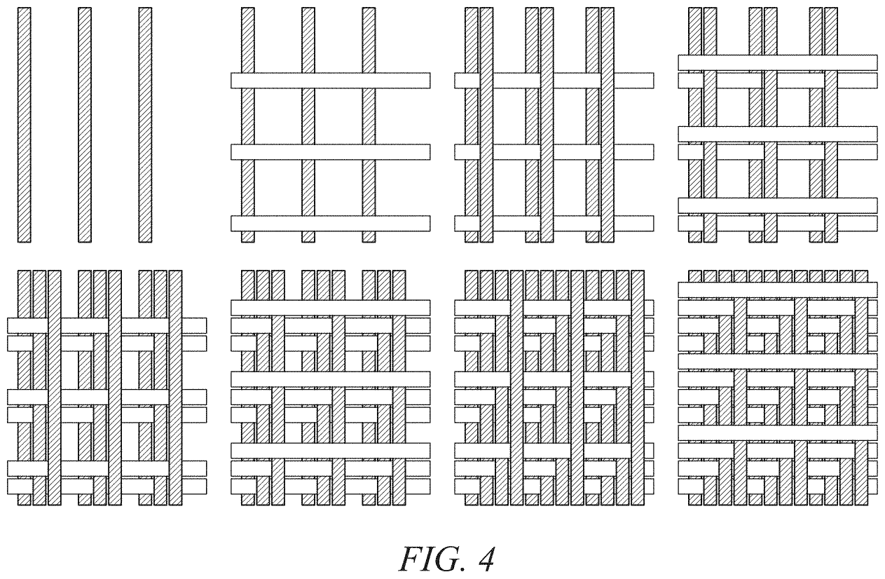

There are multiple methods which may be used to form fabrics from voided tapes for use in thermoplastic composite preforms. One method termed “rapid fabric formation” or RFF is a method used to form a thermoplastic composite preform as shown in FIG. 4. The voided tapes are sequentially laid down on top of each other in the indicated sequences so there is no weft insertion as there is with a typical weaving machine that produces a twill or plain weave, for example. RFF is one of many variants of tape-laydown methods known in the art. Tape-laydown methods are used to make thermoplastic composite fabrics and preforms with near “net-shapes”, and unlike weaving machines, RFF provides layer(s) which make a preform with almost the exact part shape desired, thus reducing fiber waste due to lower edge trim during production. RFF is a preferred method to prepare thermoplastic composite preforms when reduced edge waste is desired. Specifically, referring to FIG. 4, the sequence includes first laying three voided tapes (represented by black tapes), followed by three more voided tapes in the orthogonal direction (represented by white tapes) on top of the first layer, with this pattern repeating as shown from left to right and top to bottom in FIG. 4. Although bi-axial fabrics are shown in FIG. 4, RFF and other tape lay-down methods can be used to make tri-axial and multi-axial fabrics. FIG. 4 shows a fill factor of about 98 percent. Smaller or larger repeat patterns can be used to modify the fill factor.

When fabrics are prepared from voided tapes in which a voided tape from one layer crosses over or under a voided tape from another layer, this overlap or interlace causes the voided tape of each layer to have a wavy or undulating structure which is crimp. The degree of crimp in a fabric can have a significant influence on the mechanical properties of consolidated thermoplastic composites prepared from these fabrics. The degree of crimp may also have an effect on tow spreading or shifting as well as squeeze-out during consolidation of the thermoplastic composite preform.

Even though the RFF prepared fabric in FIG. 4, which may be used to prepare thermoplastic composite preforms disclosed herein, it is not a woven fabric, there are crimp points where the voided tapes are bent out of the plane of the fabric by the nature of the overlap of voided tapes in different layers. A fabric prepared using a plain weave has much more crimp than a fabric prepared by RFF, so typically RFF fabrics and preforms can provide enhanced mechanical properties compared to the higher crimp plain weave preforms. As with crimp in woven fabric preforms, crimp in RFF prepared thermoplastic composite preforms can stabilize the preform while under high pressure resulting in low squeeze-out compared to other fabric structures such as cross-plied, uni-directional tape layers. Desirable levels of squeeze-out during consolidation of the thermoplastic composite preforms disclosed herein is less than 11 percent.

Thermoplastic composite preforms with high fill factor (97 to 100 percent) which do not comprise crimp and which have been prepared from voided tapes disclosed herein, when exposed to pressures and temperatures to consolidate the preforms, results in a high degree of tow shifting and squeeze-out during consolidation of the thermoplastic composite preform. Such shifting and squeeze-out leads to undesirable changes in tow and fiber orientation within the plane of the consolidated thermoplastic composite, and loss of tape material at the edges. High shifting and squeeze-out typically occurs with low viscosity cross-plied uni-directional tape layers with very high fabric fill factors and which have no crimp. Attempts to minimize squeeze-out by reducing pressing pressure during consolidation of the preform may prevent complete or full consolidation, especially when voided carbon fiber tapes comprising greater than about 40K carbon fibers are used. Thermoplastic composite preforms without crimp are less desirable and typically do not attain the desired percent of theoretical strength of at least 75 percent without prohibitively high levels of squeeze-out, shifting, and fiber mis-alignment during stamp pressing of preforms with unconstrained edges.

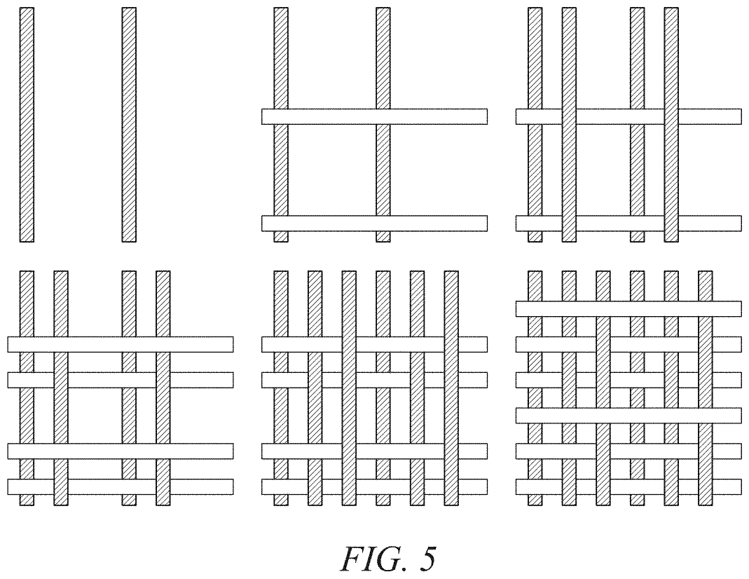

FIG. 5 shows a schematic of a multi-fabric layer thermoplastic composite preform prepared by RFF methods, but the voided tapes used to prepare the thermoplastic composite preform are spaced further apart. Such gaps between voided tapes can be applied to most non-woven and woven or knitted preform fabric layers. FIG. 5 shows a thermoplastic composite preform fabric layer having a fill factor of about 75 percent. As is well known with tape-laydown methods, including RFF, the thermoplastic composite preforms can be stabilized for handling purposes by thermal bonding, spot welding, and other methods to bond or selectively bond voided tapes together. A disadvantage of weaving machines to make tape fabrics for use in preparing thermoplastic composite preforms is that there is not any inherent way to use bonding to stabilize fabrics during weaving, and such woven fabrics preforms may be unstable and shift during weaving and handling resulting in undesirable consolidated thermoplastic composites.

### Consolidated Thermoplastic Composites

Consolidated thermoplastic composites disclosed herein may be prepared from thermoplastic composite preforms disclosed herein by exposing the thermoplastic composite preforms to a temperature and pressure sufficient to melt the thermoplastic resin and for a time period of less than about 5 minutes to allow the molten thermoplastic resin to penetrate and wet dry carbon fibers resulting in a consolidated thermoplastic composite which exhibits at least 75 percent, preferably at least 80 percent, more preferably at least 85 percent of the theoretical flexural strength of the consolidated thermoplastic composite.

In order to achieve at least 75 percent of the consolidated thermoplastic composite theoretical flexural strength, the thickness of the lamellae layers in the final consolidated thermoplastic composite should be less than about 225 μm in thickness, preferably less than about 200 μm, and most preferably less than about 170 μm for consolidated thermoplastic composites prepared from the voided tapes disclosed herein. A high width:height ratio for the voided tapes can aid the attainment of lamellae layer thicknesses below about 225 μm in the consolidated thermoplastic composites. Such voided tapes permit in-situ spreading promoted by the lubrication of the at least 10% fraction of wetted carbon fibers in the voided tapes. In other words, the low viscosities of molten thermoplastic resin tend to lubricate the tows by allowing the fibers to easily slide past each other. When less than 10% wetted carbon fibers are present in a voided tape, sufficient lubrication of the carbon fibers is not readily obtainable. The fill factor, type of fabric used (for example RFF or woven), and properties of the voided tape used to prepare the thermoplastic composite preform all have an effect on the ability of the carbon fibers to spread and be impregnated by the thermoplastic resin to produce void free composites and lamellae layers of the desired thickness. For example, voided tapes prepared from 50K carbon fiber tows and which have a single large void area and less than 10 percent wetted fiber when used in thermoplastic composite preforms, do not permit preparation of consolidated thermoplastic composites which have lamellae layers of less than about 225 μm in thickness. In general, voided tapes comprising 50K carbon fibers and a single or two large void areas, or less than about 10% percent wetted fiber, as the width:height ratio becomes less than 15, these thicker, low void tapes lead to even higher lamellae layer thicknesses than 225 μm. The lack of carbon fiber wetting and/or low number of void areas provides insufficient lubrication of the carbon fibers resulting in dry fibers interlocking with each other when under pressure, thus preventing lateral spreading and thinning of the voided tape during pressing. In other words, one or two large void areas in the voided tape in combination with a low percentage of wetted fibers in the tape, causes fiber jamming and prevents spreading of the carbon fibers in the tape during thermal pressing.

Consolidated thermoplastic composites having lamellae thicknesses of about 50 μm are known and typically manufactured from 3K to 12K tapes. The preparation of consolidated thermoplastic composites having lamellae thicknesses of about 50 μm using 50K tapes may not be possible with existing processes. In order to prepare consolidated thermoplastic composites having lamellae thicknesses of about 50 μm from 50K tapes, the carbon fibers must be spread out over a very wide distance due to inherent initial height of 50K carbon fiber tapes. Such spreading creates high friction between the fibers leading to fiber or tow breakage. To overcome such issues when preparing consolidated thermoplastic composites from 50K voided tapes, it is desirable to prepare consolidated thermoplastic composites in which the lamellae thickness ranges from about 75 to 225 μm, more preferably 75 to 200 μm, and most preferably 100 to 170 μm.

Partly aided by low crimp in the RFF prepared thermoplastic composite preforms, the voided tapes described herein permit in-situ lateral spreading of carbon fibers in woven and RFF structures during thermal pressing of the thermoplastic composite. Thermoplastic composite preforms which comprise low fill factors such as shown in FIG. 5, permit considerable in-situ lateral spreading of tapes during thermal pressing of the thermoplastic composite preforms into the unfilled areas of the preform. The thermoplastic composite preforms of FIGS. 4 and 5 are examples of preforms which result in lamellae layer thicknesses in a consolidated thermoplastic composite described herein of less than about 225 μm, preferably less than 200 μm, and most preferably less than about 170 μm when voided tapes comprising 50K carbon fibers are used.

In contrast, thermoplastic composite preforms comprising woven or RFF fabric prepared with voided tapes comprising less than about 13K carbon fibers and less than 1 percent voids, have high crimp density and severity which causes local misalignment of fibers relative to the stress direction during testing, and thus lower flexural strengths. In other words, the smaller unit cell of the RFF and woven structures with a small tape or tow like 12K or smaller, leads to a higher frequency of crimp and other defect points, which is known in the art to reduce flexural strength even if the lamellae thickness is below 170 μm and the composite is void free. With heavy tow (18K to 125K) voided tapes, the frequency of crimp points is much lower due to the larger unit cell size in the fabric preforms.

Consolidated thermoplastic composites prepared from voided tapes described herein, and wherein the thermoplastic resin is a polyamide resin, exhibit a flexural strength of at least 850 MPa, preferably at least 950 MPa, more preferably at least 1000 MPa and most preferably at least 1050 MPa in both orthogonal directions.

### Preparation of Consolidated Thermoplastic Composites

Full consolidation of thermoplastic composite preforms to produce void free consolidated thermoplastic composites as described herein can include many different forms of high pressure and temperature molding including the use of batch presses and continuous lamination presses such as double belt presses. It is desirable to use high pressure molding processes which have rapid molding or pressing cycles so parts or composite plaques can be made with total cycle times of less than about 5 minutes, preferably less than 3 minutes. However, cycle times of greater than 5 minutes may be used. Such processes do not preclude the use of compression molding even though compression molding processes may have cycle times of 20 minutes to hours and such cycle times are undesirable.

One method which may be used to prepare consolidated thermoplastic composites is stamp-pressing, which can be configured as a batch process or other automated stamp-pressing process. Stamp-pressing is a high temperature and high pressure molding process of a thermoplastic composites preform which is sandwiched between thin metal sheets and wherein the thermoplastic composite preform is heated rapidly under pressure to the desired mold temperature (330° C. for polyamide 66), followed by rapid cooling in about 30 seconds, preferably in about 20 seconds or less with separate cold platens under pressure. It is preferred that the thermoplastic composite preform is heated to a temperature which is from about 30 to 80° C. above the melting point of the thermoplastic resin being used. For high productivity, the preform may have unconstrained or free edges where lateral spreading can occur under pressure. It can also include various forms of partial edge sealing which constrain the composite materials from spreading too much laterally during pressing. The cooled consolidated thermoplastic composite can then be separated from the metal sheets to provide the desired consolidated thermoplastic composite. Such stamp-pressing molding processes typically have a cycle time of less than 5 minutes, preferably less than 3 minutes.

During stamp pressing, the heated thermoplastic composite preform may be cooled by any method used in the art. For example, the heated thermoplastic composite preform may be transferred to a separate cold press or it can be cooled by using a cold insert in the hot press which gives an equivalent thermal profile as using a separate cold press. Stamp-pressing may also use framed moulds comprising sides or edges (commonly described as a picture frame mold). Since there are no exposed free composite edges due to the picture frame mold, there is an insignificant shifting or squeeze-out of composite material at the edges. A limitation of the use of picture frame moulds is that with low viscosity resin containing voided tapes, there is flashing of resin outside of the picture frame resulting in a reduction in pressure on the composite. This pressure reduction may reduce impregnation of the carbon fibers, Flashing may also lower productivity due to difficulties in removal of the composite from the frame.

Compression molding as is known in the art is molding with all sides of the composite enclosed by mold walls. It can be difficult to remove trapped gasses during compression molding and cycle times may be slow due to the typical high thermal masses of the mold walls. Using thin mold walls or a picture frame mold in compression molding with rapid quench using a cold insert or related technology to cool the sample much more quickly than normal compression molding can be used to speed up cycle times.

The use of continuous processes such as double belt press and related processes to prepare consolidated thermoplastic composites may also be used to prepare consolidated thermoplastic composites with cycle times of less than 5 minutes, preferably less than about 3 minutes.

Regardless of the process used to prepare consolidate thermoplastic composites, as long as the pressure/temperature/time profiles of the various processes used to prepare the consolidated thermoplastic composites described herein are similar, the resulting consolidated thermoplastic composites from each process should exhibit similar properties, including at least 75 percent of the theoretical flexural strengths when using heavy tows with 18K to 125K fibers and fiber lamelle layer thicknesses less than 225 μm.

It is to be understood that stamp-pressing is a different process than stamp-forming. Stamp-forming, also known as thermoforming, is a process by which a thermoplastic composite or preform is pre-heated in the absence of pressure above the melting point of the thermoplastic resin followed by rapid transfer of the preheated thermoplastic composite into a high pressure mold at temperatures well below the melting or solidification temperatures of the resin where the preheated thermoplastic composite is exposed to high pressure. Typical stamp-forming processes are not capable of forming consolidated thermoplastic composites from voided tapes as disclosed herein due to the fact that the mold itself is too cold. Typically, the mold temperature is much lower than the melting temperature of the resin, about 150° C. for polyamides like PA6 and PA66. Thus, there is insufficient time under high temperature and pressure for the thermoplastic resin in the voided tapes to completely impregnate the dry carbon fibers and fully consolidate the composite before the resin cools to below its melting point and can no longer flow.

The consolidated thermoplastic composites described herein may be prepared by the process steps of:

a) heating a thermoplastic composite preform comprising the voided tape of claim 1 to a temperature from about 30 to 80° C. above the melting point of the thermoplastic resin and a pressure ranging from about 100 psi to about 500 psi to form a shaped thermoplastic composite preform,
b) maintaining the temperature and pressure on the shaped thermoplastic composite preform for a time sufficient to impregnate the carbon fibers of the shaped thermoplastic composite preform,
c) cooling the thermoplastic composite preform under pressure to a temperature of about 20° C. to 120° C. to provide a consolidated thermoplastic composite having a flexural strength which is at least 75 percent of the theoretical flexural strength measured according to ASTM D7264.

Consolidated thermoplastic composites prepared by processes described herein may be in any shape desired depending on the end use. For example, the consolidated thermoplastic composites may be flat, curved, or bent.

### Examples

### Materials

The thermoplastic resin composition used to prepare PA1 comprises the following ingredients:
98.1 wt. % of a blend of PA66/PA6 in a 75/25 (wt/wt %) ratio. Poly(hexamethylene hexanediamide) (PA66) was obtained from E.I. DuPont de Nemours and Company, Wilmington, Del. Poly(ε-caprolactam) (PA6) was obtained from BASF Corporation, Wyandotte, Mich., USA as Ultramid B27;
1.5 wt. % dipentaerythritol;
0.40 wt. % carbon black concentrate comprising 40 wt. % carbon black available as Americhem 31878F1 from Americhem, Cuyahoga Falls, Ohio, USA for a total concentration of 100 wt. %. The thermoplastic resin composition used to prepare PA2 to PA4 and PA6 to PA8 comprises:
98.85 wt. % of a blend of PA66/PA6 in a 75/25 (wt/wt %) ratio;
0.75% of a copper based heat stabilizer (CuI/KI) which is a blend of 7-1-1 (by weight) blend of potassium iodide, cuprous iodide, and aluminum stearate, available from Ciba Specialty Chemicals;
0.40 wt. % carbon black concentrate comprising 40 wt. % carbon black available as Americhem 31878F1 from Americhem, Cuyahoga Falls, Ohio, USA.
For resins PA1-PA4 and PA6-PA8, all PA66/PA6 blend ratios are 75/25 wt/wt. %. The melt viscosities for PA1-PA4 and PA6-PA8 vary because of the different molecular weight grades of PA66 that were used.
   PA1: PA6/PA66 having a viscosity (300 s⁻¹) of 51 Pa·s at 290° C.
   PA2: PA6/PA66 blend having a viscosity (300 s⁻¹) of 126 Pa·s at 290° C.
   PA3: PA6/PA66 blend having a viscosity (300 s⁻¹) of 152 Pa·s at 290° C.
   PA4: PA6/PA66 blend having a viscosity (300 s⁻¹) of 57 Pa s at 290° C.
   PA5: 100% PA66 available from DuPont and having a viscosity (300 s⁻¹) of 34 Pas at 290° C.
   PA6: PA6/PA66 blend having a viscosity (300 s⁻¹) of 12 Pa·s at 290° C.
   PA7: PA6/PA66 blend having a viscosity (300 s⁻¹) of 36 Pa·s at 290° C.
   PA8: PA6/PA66 blend having a viscosity (300 s⁻¹) of 100 Pas at 290° C.
   PPA1: 100 wt. % polyamide copolymer comprising poly(hexamethylene terephthalamide/2-methylpentamethylene terephthalamide) in a 50:50 molar ratio and having a viscosity (300 s⁻¹) of 35 Pa·s at 330° C. available from DuPont
   PPS1: 100 wt. % polyphenylene sulfide having a viscosity (300 s⁻¹) of 175 Pas at 310° C. and available from Celanese, Tex., USA as Fortron® PPS 0317
   PPS2: 100 wt. % polyphenylene sulfide having a viscosity (300 s⁻¹) of 125 Pas at 310° C. and available from Celanese, Tex., USA as Fortron® PPS 0309

12K carbon fiber used for all 12K tapes is a thermoplastic polyurethane-sized CF grade (Grafil 34-700WD) available from Mitsubishi Rayon Inc. (Sacramento, Calif., USA). For some comparative examples, it is woven into a fabric of areal density of 370 g/m² featuring a 2×2 twill weave. Two 12K Grafil 34-700WD tows were combined to form a 24K carbon fiber used in example E1. Mitsubishi Profil TRH50 is a 60 k carbon tow used for tapes and is available from Mitsubishi Rayon Inc. (Sacramento, Calif., USA).

50K carbon fiber used in the comparative examples and examples is a thermoplastic polyurethane-sized CF grade (Panex 35) available from Zoltek Companies, Inc. (St. Louis, Mo., USA).

### Preparation of Voided Carbon Fiber Tape

The voided carbon fiber tapes used in examples E1-E19 and comparative examples C2, C5, C6, and C7 below were prepared as follows:

The 50K tow used in the examples was obtained from Zoltek Inc., (Panex® 35), the 60 k was obtained from Mitsubishi Rayon (Profil TRH50), and the 12K tow was obtained from Mitsubishi Rayon (Grafil 34-700WD).

The pultrusion set-up includes an unwind area for the tow to be removed from the spool, where the tow is then guided over smooth metal rods, then through the impregnation chamber where it exits the chamber by passing through a slot die, and then through nip rolls and/or other appropriate wind-up equipment that provide the force to pull the tow through the entire process.

Specifically, after unwinding from the spool, and prior to entering the impregnation chamber, the fibers in the tow are pulled over 2 cm diameter smooth and round metal rods. Three such bars with an “s-wrap” configuration were used immediately before the impregnation chamber to obtain some degree of spreading and uniform tension across the tow. These metal rods are also able to capture or remove “twist” that may be present in the fiber tows. If the tow enters the chamber twisted, it will not be adequately impregnated and may cause the fiber to break when being pulled later through the die opening.

After exiting the 2 cm rods, the tow goes through an inlet to the impregnation chamber through a 20 mm×5 mm opening. The heated chamber is fed by a heated transfer line from an extruder so the chamber is filled with molten polymer resin at about 310° C. for PA66 and PA66 blend resins. The polymer is fed into the chamber counter current to the direction of the incoming carbon fiber tow, and is allowed to overflow beneath the tow inlet into the impregnation chamber. The resin in the chamber is at or close to atmospheric pressure. In other words, the impregnation chamber is not intentionally pressurized above 1 atmosphere.

In the impregnation chamber, the carbon fiber tows are pulled over spreading bar(s) that aid wetting of molten resin into the tow, and the force on the tow due to the angle and the force that the tow traverses over the spreading bar causes spreading of the tow. The greater the number of spreading bars the greater the tow spreading and somewhat more impregnation that is balanced by the total speed of the tow through the chamber. Spreading bars had diameters of 6 mm. The spreading bars had a 15.88 mm channel width and a 13 mm center-to-center distance when more than one spreading bar is used. The void level and void areas are mostly defined within the chamber and is additionally controlled by the tow speed and polymer viscosity.

At the outlet of the impregnation chamber, there is a plate that contains the exit die opening that the tow traverses through which essentially removes excess resin so the fiber fraction of the tape can be high. For 50K tow, dies with dimensions of about 12 mm×0.4 mm were used. The cross-sectional area of this die size was calculated to produce voided tapes with fiber fractions of about 44 to 60 percent with a 50K tow. For 12K tow, dies with dimensions of about 4 mm×0.3 mm were used. The cross-sectional area of this die size was calculated to produced voided tapes with fiber fractions of about 41 to 60 percent with a 12 k tow.

The partially impregnated carbon fiber tows were pulled by downstream nip rolls, and if the nip rolls are applied when the tape is still molten, then the tape can be made thinner by the force of the nip. For example, if the nip rolls were positioned close to the chamber exit, or if the tape is being produced at high speed, the tape would still be soft and molten when it was squeezed by the nip rolls, so that the width would increase and the height would decrease. Additional heaters after the chamber exit die can also be included to modify the softness of the tape as it enters the nip. This process generally is rapid and does not affect the void level substantially because this is defined by the speed, viscosity, and other parameters within the impregnation chamber defined above.

Voided tapes in Tables 1 and 3 were prepared at speeds between 1 and 13 m/min. The diameter of individual carbon fibers used in the examples and comparative examples was 7.2 μm when 50K Zoltek tow was used, 6.0 μm when 60 k Mitsubishi Profil TRH50 was used, and 7.0 μm when 12K (Grafil) and 24K (Grafil) tow was used. The ability to alter the parameters of the tape making process to obtain voided tapes having the desired properties is within the skill of one in the art.

### Test Methods

### Preparing Voided Tape Cross-Sections

Voided tape cross-sections were obtained to characterize the morphology and properties of the voided tape. For the cross-section micrographs presented in FIGS. 1-3, and summarized in Tables 1 and 3, cut-out sections of the voided tapes were completely wrapped with masking tape which acts as a film barrier layer to prevent epoxy resin from penetrating the slightly porous voided tape surface and possibly filling in some void areas in the tape. The wrapped sections were immersed in an epoxy solution to coat and surround the cut-out voided tape sections. After curing of the epoxy resin for 8 hours at 20° C., the cured cross-section was polished according to ISO 7822 (1990) to obtain a voided tape cross-section. A Keyence VHX-5000 microscope was used to obtain photos along the entire width of the cross-sections of the voided tapes at a magnification of 200 or as disclosed. The photos were spliced together as necessary to provide a magnified image of the full width of the cross-section of the voided tape. In some cases additional cross-sections from random locations along the length of the voided tape were evaluated using this process to confirm that the cross-sections were representative of the entire length of tape.

Voided tape cross-sections obtained by cutting the tape perpendicular to the fiber direction with ceramic scissors were also qualitatively evaluated at a magnification of 50 in a stereo-microscope to confirm the micrographs from the polished cross-sections described above.

The number of void areas, average tape thickness, average tape width and number of wetted fibers were determined by visual inspection of the magnified photographs.

### Method to Determine Voids in Consolidated Thermoplastic Composites

Consolidated thermoplastic composite cross-sections were prepared in the same manner as for voided tape cross-sections except the cross-sections were examined at a magnification of 500. Voids were determined using ISO7822 (1990) method C, statistical counting. The composites were not wrapped with barrier film before being exposed to the epoxy solution.

### Fiber Fraction

Fiber fraction of voided tapes is determined by measuring the total volume of solids in the voided tape and fiber volume in the voided tape. Fiber fraction is the fiber volume of the voided tape divided by the total volume of solids which comprises fibers and resin as shown by equation (I).

$$fiber fraction = \frac{[ \frac{( \frac{fiber wt \%}{100} )}{fiber ρ} ]}{[ \frac{( \frac{fiber wt \%}{100} )}{fiber ρ} ] + [ \frac{( \frac{resin wt \%}{100} )}{resin ρ} ]} \qquad ( I )$$

wherein ρ is density of the fiber or resin.

### Tape Width and Height

Tape width and height are determined by image analysis of the cross-section of voided tapes. Tape height and width are confirmed with direct measurements at several points along the cross-section using calipers and averaging the values.

### Void Volume

Void volume of voided tapes is measured by a modified buoyancy method. A test sample of voided tape is weighed in air to get an overall mass (density of air is ignored) based on the length of the voided tape test sample. The voided tapes are prepared from single or multi tow tapes which have a known weight per unit length. The thermoplastic resin and carbon fiber have a specific density. Using overall mass, densities, and weight per unit length, the fiber to resin ratio can be calculated for a voided tape. Using the identified densities for the resin and the fiber, a “zero void volume”, or “total solids volume” is calculated as shown by equation (II). Zero void volume is the volume that should be displaced by a test sample which does not comprise voids (void free).

$$zero void volume = [ \frac{\{ ( dry VTW ) \times ( \frac{fiber wt \%}{100} ) \}}{fiber ρ} ] + \\ [ \frac{\{ ( dry VTW ) \times ( \frac{resin wt \%}{100} ) \}}{resin ρ} ] \qquad ( II )$$

wherein VTW is voided tape weight.

A hanger is hung from a balance, submerged in water to a depth that would fully submerge the test sample, the depth is marked on the hanger, and tared. The test sample is attached to the hanger and the hanger submerged in water to the same marked depth on the hanger to obtain the effective mass of the sample in water (submerged mass). The test sample is subsequently removed from the water, detached from the hanger, and any water on the surface of the test sample is removed using a paper towel, and immediately after removing any surface moisture the wet mass of the sample is obtained. The wet test sample is reweighed to determine the quantity of water taken up by capillary action into voids in the test sample. The dry (mass of test sample before submersion), submerged, and wet masses of the test sample are used to calculate the volume of water displaced by the test sample as shown by equation (III). The water displaced volume is compared to the zero-void volume to determine the void volume in the test sample as shown by equation (IV). The voids are reported as a volume percent of the total voided tape volume.

$$water displaced volume = [ \frac{\begin{matrix}\{ ( dry VTW ) - ( submerged VTW ) \} + \\ \{ ( wetted VTW ) - ( dry VTW ) \}\end{matrix}}{water ρ} ] \qquad ( III )$$

wherein VTW is voided tape weight.

$$void volume = [ \frac{\{ ( water displaced volume ) - ( zero void volume ) \}}{water displaced volume} ] \qquad ( IV )$$

### Percent Wetted Carbon Fibers

The percent of wetted carbon fibers is determined from the magnified images taken from the cross-section of the voided tapes at 200 magnification. A visual count of wetted carbon fibers present in the images is made. This value is divided by the total carbon fibers in the starting tow and multiplied by 100 to arrive at percent wetted carbon fibers.

### Void Areas

The number of void areas is determined from the magnified images taken from the cross-section of the voided tapes at 200 magnification. A visual count of the void areas is made.

### Lamellae Layer Thickness

Lamellae layer thickness can be determined from the magnified images taken from the cross-section of the consolidated thermoplastic composite at a magnification of 500. The thickness or height of each lamellae layer is directly measured using image analysis. The lamellae layer thickness as reported herein for consolidated thermoplastic composites is an average of the heights of each lamellae layer in the composite. Alternatively, lamellae layer thickness can be determined from the total consolidated composite thickness divided by the number of tow layers in the thermoplastic composite preform. For example, one woven or RFF fabric layer in a bi-axial fabric preform is equivalent to two tow layers as is known in the art.

Density (g/cm³)

Density of consolidated thermoplastic composite laminates were measured by determining the volume with a micrometer and calipers, and mass with a precision balance. Because of the thermal pressing techniques used here, the consolidated composites were smooth and flat with uniform thicknesses over the areas studied.

### Viscosity

Polymer melt viscosity was measured using a capillary viscometer from Dynisco (LCR-7000) on polymers dried at 90° C. for 12 hours. For PA66 based resins, a temperature of 290° C. was used, and for other semicrystalline polymers a temperature about 30° C. above the melting point was used. The shear rate was 300 s⁻¹.

### Composite Fiber Fraction

Fiber fraction or fiber volume percent of the consolidated thermoplastic laminates were determined as follows. The density of the carbon fiber tow, thermoplastic resin and consolidated thermoplastic laminate are used to calculate the composite fiber fraction as shown by equation (V)

$$Composiste Fiber Fraction = [ \frac{\{ ( CTPCL ρ ) - ( resin ρ ) \}}{\{ ( fiber ρ ) - ( resin ρ ) \}} ] \qquad ( V )$$

wherein CTPCL is consolidated thermoplastic composite laminate.

Densities of the raw materials were acquired from the supplier technical datasheets and were 1.80 g/cm³ for Grafil fiber, 1.81 g/cm³ for Zoltek fiber. Literature densities include 1.14 g/cm³ for polyamide 6, polyamide66, and blends of the two, 1.19 for PPA1 and 1.35 g/cm³ for polyphenylene sulfide.

### Flexural Strength/Flexural Modulus

Test samples used for mechanical testing of consolidated thermoplastic composites were cut from regions near the center of the composite using a tile saw. These cut strips were 2.54 cm wide and were sufficiently long for the test as specified by ASTM D7264. Flexural strength and flexural modulus were measured on these test strips following ASTM D7264 at a test speed of 1 mm/min. Samples were dried at 90° C. for 16 hrs, and immediately tested at 20° C./35% relative humidity to prevent moisture absorption. Flexural modulus is calculated from the slope of the initial linear region of the stress-strain curve below 0.75% strain. For all flexural tests, the span length to composite thickness ratio was 32 to 1. Per ASTM D7264 a span-to-depth ratio of 32:1 was used where depth refers to the laminate thickness or height. Flexural Strength (MPa) is determined from the maximum stress of the stress-strain curve.

The above method does not exclude other related methods of strength measurement including tensile and variations in flexural strength measurement techniques as used in the art.

### Percent of Theoretical Flexural Modulus

The percent of theoretical flexural modulus (TFM) is obtained using the measured flexural modulus and TFM of the consolidated thermoplastic composite. TFM is calculated as shown in equation (VI). The percent of TFM is calculated as shown in equation (VII).

TFM=[(fiber modulus)×(composite fiber fraction)×(FFO)] (VI)

wherein FFO is fraction of fibers in test direction.

$$Percent of T F M = [ \frac{measured flexural modulus}{T F M} ] \qquad ( VII )$$

For the fabrics and consolidated thermoplastic composites disclosed herein the “fraction of fibers oriented in test direction” is 0.5 because the fabrics and thermoplastic composites used herein have an equal number of fibers going in both directions as shown in FIG. 4. The modulus of the fibers was obtained from the manufacturer of the carbon fiber tow. For the 12K and 24K carbon fiber tows the modulus value is 234 GPa, for 60 k the modulus is 250 GPa, and for carbon fiber tows of 50K the modulus value is 242 GPa.

### Percent of Theoretical Flexural Strength

The percent of theoretical flexural strength (TFS) is obtained using the measured flexural strength and TFS of the consolidated thermoplastic composite. TFS is calculated as shown in equation (VIII). The percent TFS is calculated as shown in equation (IX).

TFS=[(fiber strength)×(composite fiber fraction)×(FFO)] (VIII)

wherein FFO is fraction of fibers in test direction.

$$Percent of TFS = [ \frac{measured flexural strength}{T F S} ] \qquad ( IX )$$

For the fabrics and thermoplastic composites disclosed herein the “fraction of fibers oriented in test direction” is 0.5 because the fabrics and thermoplastic composites used herein have an equal number of fibers going in both directions as shown in FIG. 4. The tensile strength of the fibers was obtained from the manufacturer of the carbon fiber tow. For the 12K, 24K, and 60 k carbon fiber tows, the manufacturer's published strength value is 4800 MPa for both tows. For carbon fiber tows of 50K the published strength value is 4137 MPa.

Pressed uni-directional composites with 100% of the fiber in the parallel direction are the most commonly made and tested samples in the literature. For such composites, the “fraction of fibers oriented in test direction” is 1 because all fibers are oriented in one direction.

All thermoplastic composites in the Examples were bi-axially symmetric and were made without any substantial preferred orientation from the bulk to the surface layers to minimize any bias in the results due to surface fiber orientation in the test direction. It is known in the art that flexural testing may be influenced by surface fiber orientation.

### Discussion

Examples E1-E15 and comparative examples C1-C7 were prepared by stamp-pressing without the use of mold side-walls (without the use of a steel picture frame). In other words, the edges or sides of the thermoplastic composite preform are open to the environment during pressing allowing some lateral flow of carbon fiber and thermoplastic resin toward the composite edges during pressing resulting in a slightly thinner consolidated thermoplastic composite.

Using the same process parameters as Examples E1-E3 except at a slightly lower pressure of 250 psi, Example E16 was stamp-pressed with a 1.55 mm thick framed mold comprising sides or edges, commonly described as a picture frame mold, giving a total pressed composite area of 15.2 cm×15.2 cm. Since there are no free composite edges due to the picture frame during pressing, there is an insignificant lateral flow of carbon fibers and thermoplastic resin toward and past the frame edges.

Consolidated thermoplastic composites used in comparative examples C1, C2, and C4 were fabricated from polymer films and dry carbon fiber fabric layers. Polymer film layers were dried at 90° C. for at least one hour in a model 1410 vacuum oven from VWR International LLC (Radnor, Pa.). The dried polymer films were stacked alternately with dry carbon fiber fabrics to make a multilayer preform. The polymer films and the woven carbon fabric were cut to 12.7 cm×12.7 cm. Thin Kevlar® Thermount® paper (0.076 mm thick) was used as porous but heat stable frames near the outer edge of the carbon fabric layers to provide some stability to the outer edges of the preform during pressing. The Kevlar® paper frame had an outer dimension 12.7 cm×12.7 cm, and an inner dimension of 10.2 cm×10.2 cm. Two Kevlar® frames placed on the outsides of the fabric preform, and against the steel platens. These steel platens with 0.15 cm thickness and dimensions 16.5 cm×20.3 cm (width×length) were used as interfaces with the composite. Frekote® 55-NC aerosol spray received from Henkel Corp. (Rocky Hill, Conn.) was cured on the plates at 200-300° C. as a mold release agent. Because this was not an enclosed mold, and there are free composite edges, with the low viscosity resins and very high temperatures and pressures applied here, there were varying degrees of shifting of composite material at the edges under pressure for all samples made with the Kevlar® paper frames.

The resulting preforms, sandwiched between the steel platens and Kevlar® paper frames as described above, were hot-pressed into consolidated thermoplastic composites using a hand-operated hydraulic press model C from Fred S. Carver, Inc. (Summit, N.J.). Hot-pressing was performed at 330° C. temperature for thermoplastic resins comprising PA66, and about 70° C. above the respective melting points for other thermoplastic polymers such as PPA1 and PPS. After the hot-pressing step, the composites were quickly transferred to a second hand-operated hydraulic press model 3912 from Carver, Inc. (Wabash, Ind.) at room temperature and the press closed in less than 5 seconds to re-introduce pressure and cool the composites to less than 60° C. within about 15 seconds to solidify the samples and the steel platens could be removed within about 20 seconds. The actual temperature of the composite in the hot press was measured by imbedded thermocouples. The pressures and times at elevated temperature are listed in Tables 2 and 4.

Consolidated thermoplastic composites used in comparative examples C3, C5-C7, and Examples E1-E15, were fabricated from thermoplastic composite preforms comprising voided tapes using the same pressing method described for C1, C2, and C4 except that no additional resin or resin film layers were introduced since all the thermoplastic composite preforms used to make comparative examples C3, C5-C7, and Examples E1-E15 comprise voided tapes. Drying conditions before pressing were the same as for comparative example C1. The number of preform fabric layers used for each sample are disclosed in Tables 2 and 4, and the fill factors for the individual fabric preform layers were all about 95% or greater except for C2, E1, E13, E14 and E15 which were 74%, 87%, 63%, 84%, and 63%, respectively.

TABLE 1

| | C1 | C2 | C3 | C4 | C5 | C6 | C7 | E1 | E2 | E3 |
|---|---|---|---|---|---|---|---|---|---|---|
| Number of carbon fibers (K) | 12 | 12 | 50 | 50 | 50 | 50 | 50 | 24 | 50 | 50 |
| Polymer Composition | PA1 | PA2 | PA1 | PA1 | PA3 | PA4 | PPS1 | PA2 | PA5 | PA4 |
| Tape fiber fraction (%) | 54 | 38 | 49 | 49 | 47 | 38 | 52 | 38 | 48 | 51 |
| Height (mm) | 0.15 | 0.35 | 0.22 | 0.22 | 0.54 | 0.73 | 0.46 | 0.35 | 0.58 | 0.51 |
| Width (mm) | 4.0 | 3.3 | 12.0 | 12.0 | 9.8 | 11.2 | 12.5 | 6.6 | 10.6 | 10.6 |
| Width to height ratio | 26 | 9 | 56 | 56 | 18 | 15 | 27 | 19 | 18 | 21 |
| Void Volume (%) | DF | 4 | DF | DF | 19 | 25 | 22 | 4 | 26 | 23 |
| Wetted fiber (%) | 0 | 91 | 0 | 0 | 51 | 9 | 35 | 91 | 20 | 15 |
| Number of void areas | DF | 5 | DF | DF | 8 | 1 | 3 | 10 | 4 | 6 |

DF—Dry Fabric with no thermoplastic resin

Table 1 discloses materials used in the preparation of voided tapes and various properties of these voided tapes, except C1, C3, and C4. These voided tapes are used to prepare thermoplastic composite preforms and consolidated thermoplastic composites as disclosed in Table 2. Comparative examples C1, C3 and C4 represent the direct preparation of consolidated thermoplastic composites from polymer films and dry carbon fiber fabrics which is a commonly used technique. Thus, C1, C3, and C4 in Table 1 do not comprise voids or void areas and the height and width values are for the carbon fiber tows used in the preparation of thermoplastic composites. Voided tape C2 was prepared from 12K carbon fiber tow and had a width to height ratio of 9. C5, comprising 50K carbon fibers, was prepared using a polyamide thermoplastic resin having a viscosity of 152 Pa·s. C6, also comprising 50K carbon fibers, was prepared by not allowing the tow to contact the spreading bars within the pultrusion chamber during manufacture. C6 comprises a single large void area. C7 was prepared from PPS1 which had a viscosity of 175 Pas that was too high to obtain desirable wetting properties.

TABLE 2

| | C1 | C2 | C3 | C4 | C5 | C6 | C7 | E1 | E2 | E3 |
|---|---|---|---|---|---|---|---|---|---|---|
| Type of Preform Fabric | TW¹ | RFF² | RFF | PW³ | RFF | RFF | RFF | RFF | RFF | RFF |
| Preform Fabric Layers | 3 | 6 | 3 | 3 | 3 | 3 | 3 | 6 | 3 | 3 |
| Fill Factor | 98 | 74 | 97 | 97 | 94 | 98 | 99 | 87 | 96 | 96 |
| Time pressed (s) | 180 | 180 | 180 | 180 | 180 | 180 | 180 | 180 | 180 | 180 |
| Pressure (psi) | 360 | 360 | 360 | 360 | 360 | 360 | 360 | 360 | 360 | 360 |

Physical Properties

| | | | | | | | | | | |
|---|---|---|---|---|---|---|---|---|---|---|
| Thickness (mm) | 0.97 | 0.97 | 1.50 | 1.62 | 1.22 | 1.54 | 1.3 | 1.06 | 1.32 | 1.33 |
| Lamellae thickness (μm) | 161 | 81 | 249 | 270 | 203 | 257 | 224 | 89 | 220 | 222 |
| Density (g/cm³) | 1.48 | 1.48 | 1.51 | 1.39 | 1.46 | 1.48 | 1.57 | 1.46 | 1.52 | 1.53 |
| Composite Fiber Fraction (%) | 52 | 51 | 55 | 37 | 48 | 51 | 49 | 49 | 57 | 58 |
| Flexural Modulus (GPa) | 56 | 58 | 62 | 36 | 50 | 55 | 52 | 56 | 64 | 66 |
| Flexural Strength (MPa) | 863 | 846 | 755 | 360 | 690 | 771 | 450 | 970 | 907 | 951 |
| Percent of theoretical modulus (%) | 91 | 96 | 92 | 78 | 85 | 89 | 88 | 98 | 92 | 94 |
| Percent of theoretical strength (%) | 68 | 68 | 65 | 46 | 68 | 72 | 45 | 81 | 77 | 78 |

¹TW—twill weave
²RFF—Rapid Fabric Formation
³PW—plain weave

Table 2 discloses various physical parameters of thermoplastic composite preforms, conditions used to prepare consolidated thermoplastic composites from these preforms, and the resulting properties of the consolidated thermoplastic composites. All composites in Table 2 were essentially void free except C4, C5, and C7 which all comprise at least 3% voids. The presence of such voids results in reduced strength and modulus as shown in Table 2. Comparative examples C1, C3, and C4 in Table 2 show that when consolidated thermoplastic composites are directly prepared from 100% dry carbon fibers and polymer films, that the theoretical flexural strength is a maximum of about 68 percent or less. This is true even when 12K or 50K carbon fiber tows were used to prepare the composites. C2 was prepared using 12K carbon fiber tows and only exhibited 68 percent theoretical flexural strength even though C2 is fully consolidated with less than 1 percent voids. C5, prepared with 50K voided tape, shows that when the viscosity of the thermoplastic resin is too high the percent of theoretical flexural strength is only 68 percent due to the presence of unwetted fibers and 3% voids. All other Examples and Comparative Examples in Table 2, except C4 and C7, have less than 1 percent voids. C4 in Table 2 comprises greater than 5 percent voids resulting in poor flexural strengths. C4 shows that the use of polymeric films and 50K dry carbon fiber tows to prepare consolidated composites does not result in desired flexural strengths of the consolidated composites. C7, also prepared with 50K voided tape shows that when the viscosity of the thermoplastic resin is too high, the resulting theoretical flexural strength is only 45 percent partly due to unwetted fibers. C6 shows that when 50K voided tape comprises a single void and 2 percent wetted fibers, the resulting percent of theoretical flexural strength is only 72 percent. The use of a low viscosity resin in C6 cannot overcome the low concentration of wetted fibers in the voided tape used to prepare the consolidated thermoplastic composite leading to a high lamellae thickness of 257 μm and a flexural strength of only 72% of theoretical even though C6 is void free.

Examples E1 to E3 show that when voided tapes comprise 24K to 125K carbon fibers, at least 3 void areas, a void volume of between 2 and 40 percent, a thermoplastic resin having the desired viscosity, at least 10 percent wetted fibers, fiber fraction of 35 to 70 percent, as well as the desired tape width, height, and width:height ratio as defined herein, are used to prepare consolidated thermoplastic composites, these composites exhibit at least 75 percent of the theoretical flexural strength.

All the comparative examples C1 to C7 exhibit a maximum of 72 percent of the theoretical flexural strength. Examples E1 to E3 in Table 2 additionally show that consolidated thermoplastic composites prepared from voided tapes disclosed herein have lamellae thicknesses less than 225 μm which contributes to the high flexural strengths obtained. C3 and C6 have lamellae thicknesses greater than 249 μm which contributes to low flexural strengths, even though C3 and C6 are void free.

TABLE 3

| | E4 | E5 | E6 | E7 | E8 | E9 | E10 | E11 | E12 | E13 | E14 | E15 |
|---|---|---|---|---|---|---|---|---|---|---|---|---|
| Number of | 50 | 50 | 50 | 50 | 50 | 50 | 50 | 50 | 50 | 50 | 50 | 50 |
| carbon | | | | | | | | | | | | |
| fibers (K) | | | | | | | | | | | | |
| Polymer | PA5 | PA6 | PAS | PA7 | PA8 | PA7 | PA7 | PA7 | PA1 | PPA1 | PPS2 | PA5 |
| Composition | | | | | | | | | | | | |
| Tape fiber | 45 | 44 | 45 | 45 | 46 | 45 | 53 | 45 | 44 | 43 | 54 | 43 |
| fraction (%) | | | | | | | | | | | | |
| Height (mm) | 0.46 | 0.24 | 0.46 | 0.50 | 0.53 | 0.30 | 0.47 | 0.30 | 0.29 | 0.49 | 0.47 | 0.46 |
| Width (mm) | 10.1 | 20.9 | 10.1 | 10.4 | 9.7 | 19.1 | 14.6 | 19.1 | 18.6 | 10.4 | 11.9 | 10.3 |
| Width to | 22 | 86 | 22 | 21 | 18 | 63 | 31 | 63 | 63 | 21 | 25 | 22 |
| height ratio | | | | | | | | | | | | |
| Void | 5 | 9 | 5 | 9 | 20 | 16 | 32 | 16 | 18 | 3 | 19 | 2 |
| Volume (%) | | | | | | | | | | | | |
| Wetted fiber | 63 | 75 | 63 | 73 | 53 | 51 | 67 | 51 | 78 | 96 | 73 | 91 |
| (%) | | | | | | | | | | | | |
| Number of | 13 | 16 | 13 | 16 | 6 | 7 | 4 | 7 | 43 | 10 | 5 | 7 |
| void areas | | | | | | | | | | | | |

Table 3 discloses materials used in the preparation of voided tapes and various properties of these voided tapes. The total void volume for E4 to E15 ranges from 2 to 32 percent, the number of void areas ranges from 4 to 43, the percent wetted fibers ranges from 51 to 96 percent, and the width to height ratio ranging from 18 to 86. A cross-section of the tape from Example E5 is shown in FIG. 3 which comprises about 9 percent voids and 16 void areas, where only the 7 largest void areas are identified by the arrows F in FIG. 3. A cross-section of the tape from Example E9 is shown in FIGS. 1A, 1B and 2 which comprises about 16 percent voids and 7 void areas.

TABLE 4

| | E4 | E5 | E6 | E7 | E8 | E9 | E10 | E11 | E12 | E13 | E14 | E15 |
|---|---|---|---|---|---|---|---|---|---|---|---|---|
| Preform | RFF¹ | RFF | RFF | RFF | RFF | RFF | PW² | PW | RFF | RFF | RFF | RFF |
| fabric | | | | | | | | | | | | |
| type | | | | | | | | | | | | |
| Number | 3 | 5 | 3 | 3 | 3 | 6 | 3 | 3 | 5 | 6 | 4 | 6 |
| of | | | | | | | | | | | | |
| preform | | | | | | | | | | | | |
| fabric | | | | | | | | | | | | |
| layers | | | | | | | | | | | | |
| Fill Factor | 95 | 99 | 95 | 96 | 93 | 99 | 99 | 99 | 97 | 63 | 84 | 63 |
| Time | 90 | 90 | 180 | 180 | 180 | 180 | 90 | 180 | 180 | 180 | 180 | 180 |
| pressed | | | | | | | | | | | | |
| (s) | | | | | | | | | | | | |
| Pressure | 360 | 360 | 360 | 360 | 360 | 360 | 360 | 360 | 360 | 360 | 360 | 360 |
| (psi) | | | | | | | | | | | | |

Physical Properties

| | | | | | | | | | | | | |
|---|---|---|---|---|---|---|---|---|---|---|---|---|
| Thickness | 1.1 | 1.4 | 0.9 | 0.9 | 1.2 | 1.3 | 1.2 | 0.8 | 1.1 | 1.3 | 1.6 | 1.2 |
| (mm) | | | | | | | | | | | | |
| Lamellae | 175 | 143 | 148 | 157 | 195 | 109 | 193 | 127 | 106 | 109 | 197 | 102 |
| thickness | | | | | | | | | | | | |
| (μm) | | | | | | | | | | | | |
| Density | 1.46 | 1.44 | 1.49 | 1.47 | 1.49 | 1.47 | 1.48 | 1.52 | 1.47 | 1.54 | 1.52 | 1.50 |
| (g/cm³) | | | | | | | | | | | | |
| Composite | 47 | 45 | 53 | 49 | 52 | 49 | 51 | 57 | 50 | 57 | 40 | 54 |
| Fiber | | | | | | | | | | | | |
| Fraction | | | | | | | | | | | | |
| (%) | | | | | | | | | | | | |
| Flexural | 56 | 55 | 60 | 59 | 59 | 60 | 60 | 65 | 55 | 69 | 46 | 60 |
| Modulus | | | | | | | | | | | | |
| (GPa) | | | | | | | | | | | | |
| Flexural | 951 | 880 | 1094 | 930 | 885 | 1021 | 964 | 1127 | 1027 | 1158 | 609 | 1113 |
| Strength | | | | | | | | | | | | |
| (MPa) | | | | | | | | | | | | |
| Percent of | 98 | 100 | 94 | 100 | 94 | 100 | 97 | 94 | 92 | 100 | 95 | 93 |
| theoretical | | | | | | | | | | | | |
| modulus | | | | | | | | | | | | |
| (%) | | | | | | | | | | | | |
| Percent of | 97 | 94 | 100 | 92 | 82 | 100 | 91 | 96 | 100 | 99 | 75 | 100 |
| theoretical | | | | | | | | | | | | |
| strength | | | | | | | | | | | | |
| (%) | | | | | | | | | | | | |

¹RFF—Rapid Fabric Formation
²PW—plain weave

Table 4 shows that Examples E4 to E15 exhibit the desired percent of theoretical flexural strength ranging from a low of 75 percent to 100 percent. All composites in Table 4 were essentially void free except E14 which had above 3% voids. Example E14, which uses fairly high viscosity polyphenylene sulfide as the thermoplastic polymer exhibits a lower percent of theoretical flexural strength compared to examples which use polyamide based thermoplastic resins but the flexural strength of E14 is still greater than 75 percent. Table 4 also shows that Examples E4 to E15 have lamellae thicknesses less than 200 μm. Table 4 further shows a correlation between lamellae thickness and flexural strengths. Examples E6, E9, E12, and E13 exhibit at least 99 percent of theoretical flexural strength and have a lamellae thickness of less than 150 μm. All examples in Table 4 were pressed for 180 or 90 seconds at 330° C. showing that consolidated thermoplastic composites which exhibit at least 75 percent of theoretical flexural strength can be prepared with cycle times of 3 minutes or less.

Example E16 was prepared by stamp-pressing with constrained preform edges using a picture frame. Using the same 50K voided tape from Example E10, a consolidated thermoplastic composite was made with the same preform fabric structure but stamp-pressing was done with a steel picture frame mold. Five fabric layers were used. Since there are no free laminate edges due to the picture frame mold, there is minimal squeeze-out of composite material or flashing of resin past the edges of the frame while under 250 psi pressure and a temperature of 330 C for 180 seconds at which point the sample was transferred to the cold pressing zone and cooled in less than 20 seconds. The consolidated composite thickness was 1.77 mm. Because of a lamellae thickness of 177 μm, a flex strength of 921 MPa was obtained which is 81% of the theoretical strength. The density was 1.50 g/ml, with a fiber fraction of 53 vol % and a flex modulus of 62 GPa. Preparation of consolidated thermoplastic composites using stamp-pressing with a picture frame mold is but one of many processes known in the art which may be used to prepare consolidated thermoplastic composites.

Example E17 was prepared by a stamp-pressing process with unconstrained laminate edges at identical temperature and pressure and using the same area preform and 50K voided tape as Example E5 except the heating time was 180 seconds. The consolidated thermoplastic composite of example E17 was prepared from a thermoplastic composite preform comprising 7 RFF fabric layers and having a fabric fill factor of 88%. Example E5 has a fill factor of 99%. During pressing of the thermoplastic composite preform of example E17 the squeeze-out is 9% which is surprising due to the low viscosity (12 Pas at 290° C.) thermoplastic resin in the voided tape of the preform. Example E5 has a fill factor of 99% and the squeeze-out during pressing was 27%. The consolidated thermoplastic composite of Example E17 has a thickness of 1.50 mm and a lamellae thickness of 107 μm, resulting in a flexural strength of 855 MPa which is 82% of the theoretical flexural strength. The density of E17 was 1.477 g/ml, with a fiber fraction of 50 vol % and a flex modulus of 55 GPa.

Example E18 was prepared using the same conditions as E17 except a larger press was used and the pressure was 150 psi. E18 comprises 3 RFF preform fabric layers with dimensions of 27 cm×27 cm, and the pressing time, not including cooling time, was 180 s. The same 50K voided tape used in Example E5 was used in E18. The thermoplastic composite preform of E18 had a fill factor of 98% which resulted in a squeeze-out of 23% during preparation of the consolidated thermoplastic composite.

E18 and E5 exhibit squeeze-out during consolidation of 23 and 27% and both have fill factors of 98 and 99% respectively. These results show that fill factor of the preform influences the amount of squeeze-out during consolidation. Very high fill factors of about 95% or greater may result in undesirable levels of squeeze-out. The consolidated thermoplastic composite of E 18 has a thickness of 0.88 mm and a lamellae thickness of 150 μm resulting in a flexural strength of 880 MPa which is 93% of the theoretical flexural strength. The density of E 18 was 1.451 g/ml with a fiber fraction of 46 vol % and a flex modulus of 53 GPa.

Example E19 was prepared using the same conditions as E18 except the pressure was 200 psi and the pressing time, not including cooling time, was 120 s. The fabrics for E19 were prepared from the same 50K voided tape as E5. The consolidated thermoplastic composite of E19 was prepared from a preform comprising 6 RFF fabric layers with a fabric fill factor of 85%. During consolidation of the preform of E19, squeeze-out was only 10%. The consolidated thermoplastic composite of E19 has a height of 1.43 mm and a lamellae thickness of 119 μm resulting in a flexural strength of 930 MPa which is 92% of the theoretical strength. The density was 1.47 g/ml, with a fiber fraction of 50 vol % and a flex modulus of 52 GPa.

As exemplified by examples E17, E18, and E19, the percentage of squeeze-out during consolidation may be minimized by having a fill factor of about 50 and 96%, preferably about 60 to 96%, and most preferably about 70 to 89% when using voided tapes disclosed herein and when the consolidated composite preform comprises fabric layers prepared by RFF or woven processes. High levels of squeeze-out during consolidation may not necessarily have a direct effect on the flexural strength of the consolidated thermoplastic composite unless substantial fiber mis-orientation occurs. However, high levels of squeeze-out are commercially undesirable due to the waste and difficulties of clean up after the consolidation process.

TABLE 5

| | E20 | E21 |
|---|---|---|
| Number of carbon fibers (K) | 40 | 40 |
| Polymer Composition | PA7 | PA7 |
| Tape fiber fraction (%) | 52 | 52 |
| Height (mm) | 0.23 | 0.23 |
| Width (mm) | 12 | 12 |
| Width to height ratio | 52 | 52 |
| Void Volume (%) | 6 | 6 |
| Wetted fiber (%) | 65 | 65 |
| Number of void areas | 15 | 15 |

TABLE 6

| | E20 | E21 |
|---|---|---|
| Preform fabric type | Cross-ply | RFF |
| Number of preform fabric layers | 8 | 4 |
| Fill Factor | 96 | 96 |
| Time pressed (s) | 180 | 180 |
| Pressure (psi) | 300 | 300 |
| Physical Properties | | |
| Thickness (mm) | 1.2 | 1.12 |
| Lamellae thickness (μm) | 150 | 140 |
| Density (g/cm³) | 1.48 | 1.47 |
| Composite Fiber Fraction (%) | 52 | 52 |
| Flexural Modulus (GPa) | 60 | 65 |
| Flexural Strength (MPa) | 920 | 948 |
| Percent of theoretical modulus (%) | 92 | 100 |
| Percent of theoretical strength (%) | 74 | 76 |

Examples E20 and E21 and Comparative C8 were consolidated using the same conditions as E17 except a larger press was used and the pressure was 300 psi. The pressing time, not including cooling time, was 180 s. 60K tow was used to make voided tape, which was then slit to 12 mm with each 12 mm tape comprising about 40 k fibers with voids of 6% as shown in Table 5 and were used in the preparation of E20, E21, and C8.

E20 comprised 8 unidirectional fabric layers in the preform with dimensions of 27 cm×27 cm, arranged in a cross-plied (0/90/0/90/0/90/0/90) configuration. The thermoplastic composite preform of E20 had a fill factor of 96% which resulted in a fairly low squeeze-out of 9% of the consolidated thermoplastic composite with a flex strength and modulus of 920 MPa and 60 GPa, respectively, as shown in Table 6.

Comparative C8 comprised 8 unidirectional fabric layers in the preform with dimensions of 27 cm×27 cm, arranged in a cross-plied (0/90/0/90/0/90/0/90) configuration. The thermoplastic composite preform of C8 had a fill factor of 98.5% resulting in a squeeze-out of 14% of the consolidated thermoplastic composite. The composite had a flex strength and modulus of 1008 MPa and 64 GPa, respectively.

E21 comprised 4 fabric layers in the preform with dimensions of 27 cm×27 cm, prepared by RFF. The thermoplastic composite preform of E21 had a fill factor of 96% which resulted in a squeeze-out of 3% of the consolidated thermoplastic composite. The composite had a flex strength and modulus of 948 MPa and 65 GPa, respectively, as shown in Table 6. These results show that low squeeze-out and high strength can be attained with 96% fill factor and 6% voided tapes.

Example E20 shows that the 96% fill factor preforms with cross-plied narrow tapes provide a low composite squeeze-out and high strength. The low squeeze-out is surprising because it is well known that with low viscosity tape cross-plied preforms without crimp comprising layers with 100% fabric fill factor, that squeeze-out is very high. As shown in Comparative C8, even with 98.5% fill factor, the squeeze-out of 14% is unacceptably high.

1. A voided tape comprising:
a) from 18K to 125K carbon fibers,
b) a thermoplastic resin having a viscosity of about 10 to about 150 Pa·s when measured using a capillary viscometer at a temperature 30° C. above the thermoplastic resin melting point and at a shear rate of 300 s⁻¹,
c) at least 3 void areas,
d) a fiber fraction ranging from about 35 to 70 percent,
e) a void volume ranging from about 2 to about 50 percent when measured by a buoyancy method, and
f) at least 10 percent wetted carbon fibers;
wherein:
the voided tape width ranges from about (0.00019 mm×the number of carbon fibers in (a)) to about (0.0016 mm×the number of carbon fibers in (a)),
the voided tape width:height ratio ranges from about 10 to 1000.

2. The voided tape of claim 1 comprising 24K to 125K carbon fibers.

3. The voided tape of claim 1 comprising a single carbon fiber tow.

4. The voided tape of claim 1 comprising 48K to 60K carbon fibers.

5. The voided tape of claim 1 wherein the void volume ranges from about 10 to 35 percent.

6. The voided tape of claim 1 wherein the width ranges from about (0.0003 mm×the number of carbon fibers in (a)) to about (0.0010 mm×the number of carbon fibers in (a)).

7. The voided tape of claim 1 wherein the width:height ratio ranges from about 30 to 130.

8. The voided tape of claim 1 comprising at least 4 void areas.

9. The voided tape of claim 1 comprising 30% to 97% wetted fibers.

10. A thermoplastic composite preform comprising:
a) at least one carbon fiber fabric layer in the form of woven, RFF, non-woven, uni-directional, or cross-ply structures or a combination of these prepared from the voided tape of claim 1, and
b) from about 60 to 100 percent fabric fill factor.

11. The thermoplastic composite preform of claim 10 wherein the at least one carbon fiber fabric layer is in the form of woven or RFF fabric structures.

12. The thermoplastic composite preform of claim 10 comprising bi-axial carbon fiber fabric symmetry.

13. The thermoplastic composite preform of claim 10 comprising multi-axial carbon fiber fabric structures.

14. The thermoplastic composite preform of claim 11 wherein the fabric fill factor ranges from about 60 to 96 percent.

15. A consolidated thermoplastic composite prepared from the thermoplastic composite preform of claim 10, wherein said consolidated thermoplastic composite exhibits a flexural strength greater than or equal to 75 percent of the theoretical flexural strength when measured according to ASTM D7264, and wherein said consolidated thermoplastic composite has an average lamellae layer thickness ranging from about 100 to 200 μm.

16. The consolidated thermoplastic composite of claim 15, wherein the flexural strength is greater than or equal to 80 percent of the theoretical flexural strength.

17. The consolidated thermoplastic composite of claim 15, wherein the flexural strength is at least 950 MPa in orthogonal directions when measured according to ASTM D7264.

18. A consolidated thermoplastic composite prepared from the thermoplastic composite preform of claim 14, wherein said consolidated thermoplastic composite exhibits a flexural strength greater than or equal to 75 percent of the theoretical flexural strength when measured according to ASTM D7264, and wherein said consolidated thermoplastic composite has an average lamellae layer thickness ranging from about 100 to 200 μm.

19. A consolidated thermoplastic composite prepared from the thermoplastic composite preform of claim 14 by stamp pressing with unconstrained edges wherein the consolidated thermoplastic composite has less than 11 percent squeeze-out.

20. A process comprising the steps of:
a) heating a thermoplastic composite preform comprising the voided tape of claim 1 to a temperature from about 30 to 80° C. above the melting point of the thermoplastic resin and a pressure ranging from about 100 psi to about 500 psi to form a shaped thermoplastic composite preform,
b) maintaining the temperature and pressure on the shaped thermoplastic composite preform for a time sufficient to impregnate the carbon fibers of the shaped thermoplastic composite preform,
c) cooling the thermoplastic composite preform under pressure to a temperature of about 20° C. to 120° C. to provide a consolidated thermoplastic composite having a flexural strength which is at least 75 percent of the theoretical flexural strength measured according to ASTM D7264.

21. The process of claim 20 wherein the pressure in step (a) ranges from about 150 psi to about 360 psi.

22. The process of claim 20 wherein the temperature and pressure in step (b) are maintained for a time from about 30 to about 300 seconds.

23. The process of claim 20 wherein step (c) occurs in 30 seconds or less.

24. A process comprising the steps of:
a) stamp-pressing with unconstrained edges a thermoplastic composite preform having a fabric fill factor of 60 to 96 percent prepared from the voided tape of claim 1 at a temperature from about 30 to 80° C. above the melting point of the thermoplastic resin of the preform and a pressure ranging from about 100 psi to about 500 psi,
b) maintaining the temperature and pressure on the thermoplastic composite preform for a time period sufficient to impregnate the carbon fibers of the thermoplastic composite preform,
c) cooling the thermoplastic composite preform under pressure to a temperature of about 20° C. to 120° C. to provide a consolidated thermoplastic composite having less than 11 percent squeeze-out.
